(19) United States
(12) Patent Application Publication
(10) Pub. No.: US 2025/0370101 A1
(43) Pub. Date: Dec. 4, 2025

(54) LOCAL SENSOR DATA FILTERING AND ANONYMOUS TRACKING FOR MONITORED ENVIRONMENTS

(71) Applicant: UnitedHealth Group Incorporated, Minnetonka, MN (US)

(72) Inventors: Lawrence David Garber, Southborough, MA (US); Sean N. Goodman, Minnetonka, MI (US); Herk Anthony Confer, San Francisco, CA (US); Logan Garber, Hopkinton, MA (US); Matthew Obetz, Southborough, MA (US)

(21) Appl. No.: 19/007,307

(22) Filed: Dec. 31, 2024

Related U.S. Application Data
(60) Provisional application No. 63/652,452, filed on May 28, 2024.

(51) Int. Cl. G01S 7/41; G01S 13/56

(52) U.S. Cl. CPC G01S 7/415; G01S 13/56

(57) ABSTRACT

Various embodiments of the present disclosure provide a local sensor processing technique process that improves the functionality of a computer in various aspects. The technique comprises receiving sensor data and generating movement data based on the sensor data that is reflective of a candidate movement for a tracking target within the monitored environment, generating movement feature values based on the movement data and a plurality of excursion feature parameters associated with (a) an entity signature definition and (b) one or more defined contextual attributes, generating a plurality of sensor-based feature values for an excursion event based on the movement feature values and historical movement feature values, identifying a triggering event based on a comparison between the sensor-based feature values and excursion event criteria, and in response to detecting the triggering event, providing an excursion message that comprises the plurality of sensor-based feature values.

### CROSS REFERENCE TO RELATED APPLICATIONS

This application claims priority to U.S. Provisional Application No. 63/652,452, entitled “Anonymous Tracking Using Ambient Sensing Device”, filed May 28, 2024, the entirety of which is incorporated by reference herein for all purposes.

### BACKGROUND

Various embodiments of the present disclosure address technical challenges related to ambient sensing within monitored environments. Often, monitored environments may be facilitated by a combination of devices, including a sensing device and network connected, remote devices. Traditional device configurations for monitoring environments present several technical challenges, including (i) privacy challenges due to their use of personally identifiable information (PII) and/or facial features that expose sensitive information of an entity within an environment and (ii) robust computing resource requirements for continuously monitoring an active environment. For example, traditional device configurations that leverage PII or facial features to identify occupants within a monitored environment are susceptible to network attacks that may expose sensitive information to malicious parties. Moreover, traditional device configurations generate sensor data using a sensing device that transmits the sensor data to a remote system for processing. In these configurations, sensor data is continuously transmitted to the remote system for processing, regardless of the relevance of the sensor data to a predictive task. This is inefficient and leads to significant computing memory and processing waste.

Various embodiments of the present disclosure make important contributions to traditional ambient sensing technology by addressing these technical challenges, among others.

### BRIEF SUMMARY

Various embodiments of the present disclosure provide improved ambient sensing techniques that reduce computing resource expense and enhance privacy within a monitored. Some embodiments of the present disclosure provide a device configuration that includes a sensing device and a network connected prediction system. The sensing device includes a local filtering mechanism that locally processes and filters sensor data based on a relevance of the sensor data to a predictive task. In this way, the sensing device may limit data transmissions between the sensing device and the network connected prediction system. The network connected prediction system may implement automated calibration and prediction techniques for processing the pre-filtered data transmissions to track activity within an environment without the use of PII or facial features of the entities within the environment. To do so, the prediction system may leverage tracking target signatures that identify targets within an environment based on point cloud features that are unusable outside the scope of a particular predictive task. In this way, the configuration of devices, as described in the present disclosure, limits data transmissions between the component devices and leverages data within the transmissions to track activity within the environment without exposing its occupants to privacy risks.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is an example data flow diagram of a local sensor filtering technique in accordance with some embodiments discussed herein.

FIG. 5 is an example data flow diagram of an automated calibration technique in accordance with some embodiments discussed herein.

FIG. 6 is an example data flow diagram of a privacy-enhanced identification and tracking technique in accordance with some embodiments discussed herein.

FIG. 7 is an operational example of a monitored environment in accordance with some embodiments discussed herein.

FIG. 8 is a flowchart diagram of a local sensor filtering process in accordance with some embodiments discussed herein.

FIG. 9 is a flowchart diagram of an automated calibration process in accordance with some embodiments discussed herein.

FIG. 10 is a flowchart diagram of a privacy-enhanced identification and tracking process in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

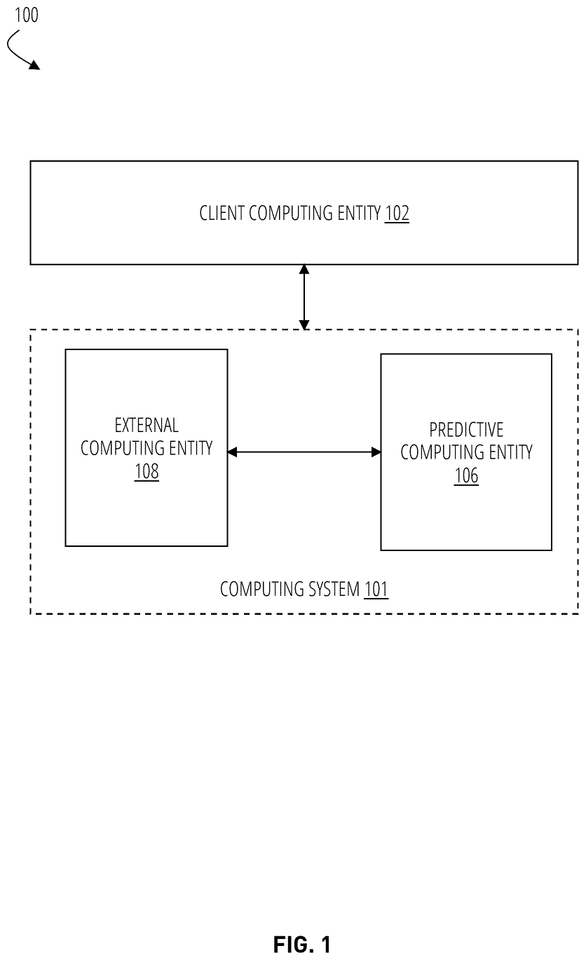

FIG. 1 provides an example overview of an architecture 100 in accordance with some embodiments of the present disclosure. The architecture 100 includes a computing system 101 configured to receive data, such as sensor data, an excursion message, and/or the like, from client computing entities 102, process the data to generate predictive features and/or predictive outputs, and provide the predictive features and/or predictive outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate tracking target signatures, predictive outputs, and/or the like. The models may form one or more machine learning inference and/or training pipelines that may be configured to train a machine learning model and/or leverage a machine learning model to perform a predictive task. This technique will lead to more accurate and reliable sensor processing techniques that may be efficiently used for a diverse set of different cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as predictive outputs, and/or the like, and provide the generated outputs (and/or a derivative thereof) to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques (e.g., local filtering techniques, tracking techniques, prediction techniques, and/or the like) described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., local filtering techniques, tracking techniques, prediction techniques, and/or the like) described herein. The external computing entities 108, for example, may include and/or be associated with one or more entities that may be configured to receive, transmit, store, manage, and/or facilitate datasets, such as excursion parameters, configuration parameters, target log files, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include container databases, order databases, and/or the like that may collect data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

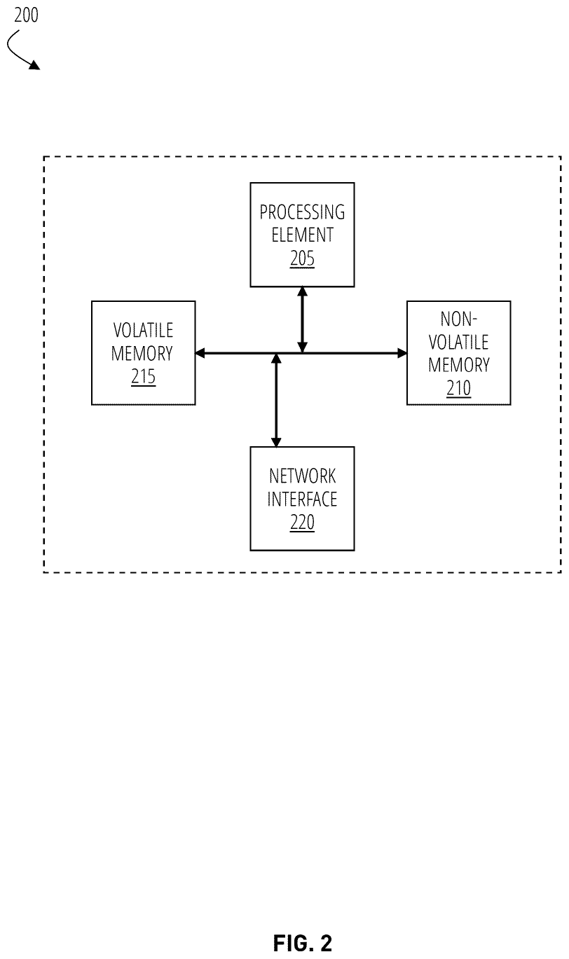

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

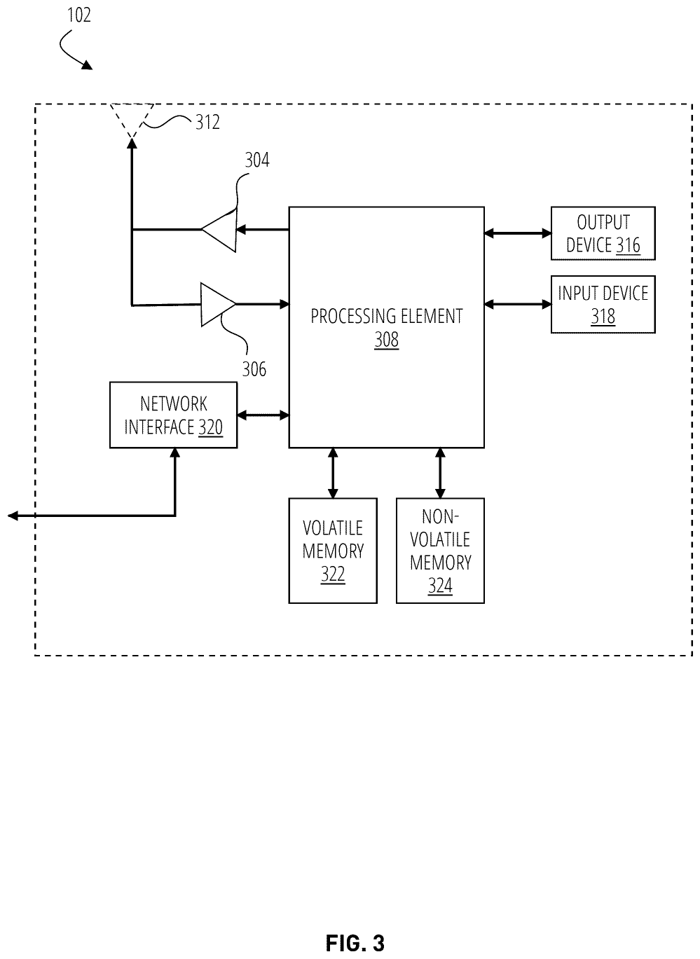

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly. In some example, the antenna 312 may comprise a radio antenna, radio detection and ranging (radar) antenna, and/or the like. For instance, in the case of a radar antenna, the transmitter 304 may be configured to emit short pulses of radio waves (e.g., at tenth of a second intervals) to detect and locate object by measuring a time between a pulse and a return signal received by the receiver 306. The return signals, for example, may comprise radar data that may be provided to downstream system for various processing tasks of the present disclosure.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “ambient sensing device” refers to a computing entity that includes one or more sensors, one or more processors, and memory that are collectively configured to perform one or more operations of the present disclosure. An ambient sensing device, for example, may include a housing, a mounting bracket, and one or more electrical components placed at least partially within the housing. The one or more electrical components, for example, may include a radar sensor, an onboard microchip (e.g., a logic chip, a memory chip, system-on-a-chip, application-specific integrated chip (ASIC), etc.) electrically connected to the radar sensor, one or more communication interfaces, and/or one or more interactive elements.

The microchip, for example, may include one or more integrated memory components configured to provide local, on-chip memory storage for the ambient sensing device. In addition, or alternatively, the microchip may include one or more integrated processing components configured to locally process data stored in on-chip memory. In some examples, the one or more communication interfaces may include one or more wireless network interfaces, such as one or more Wi-Fi interfaces, Bluetooth interfaces, and/or the like. The one or more interactive elements may include one or more push buttons, lights, screens, microphones, speakers, and/or the like. By way of example, the one or more interactive elements may include three different colored lights that may be used for troubleshooting when there is, for instance, a communication issue. In addition, or alternatively, the one or more interactive elements may be activated in response to a predictive output, as described herein.

In some examples, computer-readable instructions may be locally stored in on-chip memory of the ambient sensing device that, when locally executed by the one or more processors of the ambient sensing device, may cause the ambient sensing device to perform one or more operations of the present disclosure. By way of example, the ambient sensing device may include one or more tracking components, such a Texas Instruments (TI) 3D people tracking software that may locally process sensor data to identify objects (and/or point clouds thereof) within a monitored environment, extract movement data reflective of the objects, and report the movement data at a reporting time interval.

In some examples, the ambient sensing device may be mounted within a monitored environment using a mounting bracket. The mounting bracket, for example, may include an adhesive material, a wall mount bracket, and/or the like. As described herein, one or more ambient sensing devices may be mounted within a monitored environment to generate movement data for one or more tracking targets within the monitored environment.

In some embodiments, the term “radar sensor” refers to a sensing component of an ambient sensing device. A radar sensor, for example, may include a pulse radar, a continuous wave radar, a frequency-modulated continuous wave radar, a deep dive continuous wave radar, and/or the like. In some examples, the radar sensor may include a millimeter wave radar sensor, such as one or more TI mm Wave radar sensors.

In some embodiments, the term “sensor data” refers to sensor signals received using the radar sensor. The sensor data, for example, may include radio frequency (RF) signals that are received by the radar sensor and converted (e.g., using analog to digital converter, etc.) to a digital representation of the RF signals. In some examples, the sensor data may reflect one or more candidate movements within a monitored environment by mapping the monitored environment at a particular frequency and comparing the mapped monitored environment to a base environment map. For example, the sensor data may include one or more protrusions or anomalies that conflict with a base environment map and may be reflective of a candidate movement of an object within the monitored environment.

In some embodiments, the term “monitored environment” refers to an environment that includes an ambient sensing device. A monitored environment may depend on a prediction domain and/or a use case for an ambient sensing device. For example, a monitored environment may include one or more rooms, hallways, and/or the like, within a facility (e.g., a secured facility, etc.), a housing unit, and/or another indoor environment. In addition, or alternatively, a monitored environment may include one or more yards, alleys, ingress/egress ways, and/or the like, within an outdoor environment. In some examples, with reference to a clinical prediction domain, a monitored environment may include a portion of a housing unit in which a monitored patient resides.

In some embodiments, the term “tracking target” refers to an entity that is expected to move within a monitored environment. A tracking target may depend on a prediction domain and/or a use case for an ambient sensing device. For example, a tracking target may include person, animal, and/or object (e.g., robot, equipment, etc.) that visits, resides in, works in, has a security clearance for, and/or otherwise moves within a monitored environment. In addition, or alternatively, a tracking target may include a person, animal, and/or object (e.g., robot, equipment, etc.) that is prohibited from a monitored environment (e.g., a banned individual, etc.). In some examples, returning to the clinical prediction domain example, a tracking target may include a monitored patient.

In some embodiments, the term “movement data” refers to point cloud data associated with a candidate movement. The point cloud data, for example, may be extracted from sensor data received over a reporting time interval. For example, the point cloud data may include a three-dimensional point cloud reflective of an object and a candidate movement within a monitored environment.

In some embodiments, the term “reporting time interval” refers to a data parameter that defines a reporting frequency of a radar sensor. The reporting time interval may be a configurable parameter. In some examples, the reporting time interval may include a tenth of a second interval.

In some embodiments, the term “movement feature value” refers to a data value that is extracted from movement data. A movement feature value, for example, may include an attribute of a three-dimensional point cloud, such as a point cloud height, a point cloud width and/or girth, a point cloud's centroid location, point cloud velocity, a point cloud acceleration, a point cloud confidence level, a point cloud gating function gain, a point cloud tracking error variance, a point cloud group variance, and/or any other metadata extracted from movement data. In some examples, a plurality of movement feature values may be extracted from movement data for each of a plurality of excursion feature parameters. By way of example, a point cloud height (e.g., object height) may be extracted for an aggregated height parameter, a point cloud width and/or girth (e.g., object width and/or girth) may be extracted for an aggregated width and/or girth parameter(s), a point cloud's centroid location (e.g., object's three dimensional location in X, Y, Z coordinates) may be extracted for an distance parameter, point cloud velocity (e.g., object's three dimensional velocity in X, Y, Z directions) may be extracted for an aggregated velocity parameter, a point cloud acceleration velocity (e.g., object's three dimensional acceleration in X, Y, Z directions) may be extracted for an aggregated acceleration parameter, a point cloud confidence level (e.g., probability between 0 and 1) may be extracted for an aggregated confidence parameter, a point cloud gating function gain (e.g., an amount an object's point cloud may grow that be set based on expected tracking errors, expected target maneuvers, uncertainties in the detection layer, etc.) may be extracted for an aggregated gain parameter, a point cloud tracking error variance (e.g., covariance matrix showing variance of location and velocity predictions vs. reality between frames, which are the four values in the diagonal in the covariance matrix) may be extracted for an aggregated tracking error variance parameter, a point cloud group variance (e.g., covariance matrix showing variance of location and velocity of the point cloud over time, which are the four values in the diagonal in the covariance matrix) may be extracted for an aggregated group variance parameter, and/or any the like.

In some examples, a plurality of movement feature values may be extracted from movement data for each of a plurality of sequential candidate movements. Each of the plurality of sequential candidate movements, for example, may be associated with movement data reported at a particular reporting time of a reporting time interval. In some examples, an object identifier may be generated to track the movement of an object across multiple reporting times of a reporting time interval. For example, in response to receiving movement data at a first reporting time, a plurality of movement feature values may be extracted from the movement data and compared to a plurality of historical movement feature values extracted at one or more reporting times before the first reporting time. In response to a match, an object identifier assigned to the plurality of historical movement feature values may be assigned to the plurality of movement feature values. Otherwise, a new object identifier may be generated and assigned to the plurality of movement feature values. In this manner, a sequence of movement feature values may be tracked and aggregated over one or more reporting times to generate a plurality of sensor-based feature values respectively corresponding to the plurality of excursion feature parameters.

In some embodiments, the term “excursion feature parameter” refers to data parameter that describes a feature value of interest for an excursion event. An excursion feature parameter, for example, may include a predefined parameter that describes a measurement from movement data received over a sequence of candidate movements. In some examples, an excursion feature parameter may include an aggregated feature parameter, a distance parameter, a time parameter, among others. By way of example, a plurality of excursion feature parameters may include: (i) an aggregated height parameter defining a mean, standard deviation, and/or median point cloud height across a sequence of point clouds, (ii) an aggregated width and/or girth parameter(s) defining a mean, standard deviation, and/or median point cloud width across a sequence of point clouds, (iii) a distance feature parameter defining a distance travelled from a first point cloud to a last point cloud in the sequence of point clouds, (iv) a duration feature parameter defining a time between a first point cloud and a last point cloud in the sequence of point clouds, (v) an aggregated velocity parameter defining a mean, standard deviation, and/or median point cloud velocity, (vi) an aggregated acceleration parameter defining a mean, standard deviation, and/or median point cloud acceleration, (vii) an aggregated confidence parameter defining a mean, standard deviation, and/or median point cloud confidence level, (viii) an aggregated gain parameter defining a mean, standard deviation, and/or median point cloud gating function gain, (ix) an aggregated tracking error variance parameter defining a mean, standard deviation, and/or median point cloud tracking error variance, (x) an aggregated group variance parameter defining a mean, standard deviation, and/or median point cloud group variance, and/or any other configurable parameter.

In some embodiments, the term “entity signature definition” refers to a set of excursion feature parameters that is reflective of a tracking target's identity within a tracking system. An entity signature definition, for example, may include a plurality of point cloud attributes that may be used to identify a tracking target without personally identifiable information (PII), such as a name, facial features, and/or the like. In some examples, an entity signature definition may include semi-static feature parameters that are not expected to deviate over time. By way of example, an entity signature definition may include two or more of (i) the aggregated height parameter, (ii) the aggregated width and/or girth parameter(s), (iii) the aggregated velocity parameter, (iv) the aggregated acceleration parameter, (v) the aggregated confidence parameter, (vi) the aggregated gain parameter, (vii) the aggregated tracking error variance parameter, and/or (viii) the aggregated group variance parameter.

In some embodiments, the term “defined contextual attributes” refers to a set of excursion feature parameters that are reflective of a tracking target's activity level within a monitored environment. A defined contextual attribute, for example, may include activity data that may be used to characterize a level of a tracking target's activity over time. In some examples, a defined contextual attribute may include dynamic feature parameters that are expected to deviate over time. By way of example, a defined contextual attribute may include an aggregated velocity parameter, a distance feature parameter, and/or a duration feature parameter.

In some embodiments, the term “sensor-based feature value” refers to a data value that is measured from one or more movement feature values and reflects a characteristic of a potential excursion event. A sensor-based feature value, for example, may include a data value for an excursion feature parameter. The sensor-based feature value may include an aggregated feature value, a distance feature value, and/or a duration feature value depending on the excursion feature parameter.

An aggregated feature value, for example, may include a mean, standard deviation, median, and/or any other aggregation of a plurality of movement feature values for a particular excursion feature parameter.

A distance feature value may be a distance measurement between a plurality of location measurements (e.g., a point cloud's centroid locations) of the plurality of movement feature values. For example, a distance feature value may include a straight line, three-dimensional distance measurement between a first location measurement and a last location measurement in a sequence of location measurements. In addition, or alternatively, the distance measurement may include a straight line, horizontal plane two-dimensional distance measurement between a first location measurement and a last location measurement in a sequence of location measurements. In addition, or alternatively, the distance feature value may include a summation of a plurality of two-dimensional and/or three-dimensional distance measurements between each sequential pair of location measurements in a sequence of location measurements.

A duration feature value may be a temporal measurement between a plurality of time measurements (e.g., a point cloud times) of the plurality of movement feature values. For example, the duration feature value may include a temporal measurement between a first-time measurement and a last time measurement in a sequence of time measurements. By way of example, a duration feature value may include a time measurement between a creation time of a new object identifier and a termination time of the object identifier at which movement data is no longer received for the object identifier.

In some embodiments, the term “excursion event” refers to a sequence of candidate movements that satisfy excursion event criteria. An excursion event, for example, may be detected based on a comparison of a plurality of sensor-based feature values generated for a sequence of candidate movements to excursion event criteria. In some examples, the plurality of sensor-based feature values may be continuously generated, locally by the ambient sensing device, until a triggering event occurs responsive to the plurality of sensor-based feature values satisfying the excursion criteria. In some examples, an excursion message may be initiated from the ambient sensing device in response to the triggering event. In this way, the ambient sensing device may leverage excursion event criteria to filter communications between the ambient sensing device and prediction systems.

In some embodiments, the term “excursion event criteria” refers to a set of message filtering constraints that define local message criteria for providing an excursion message to a prediction system. The excursion event criteria, for example, may include a plurality of configuration parameters that respectively define parameter-level criteria for establishing a triggering event at an ambient sensing device. In some examples, the ambient sensing device may continuously generate a plurality of sensor-based feature values for an object identifier until a termination time of the object identifier (e.g., when the movement data 408 does not include data for the object identifier for a threshold number of reporting times of a reporting time interval). In the event that the plurality of sensor-based feature values satisfies the excursion event criteria, a triggering event may be established for the plurality of sensor-based feature values. Otherwise, the plurality of sensor-based feature values may be discarded without transmitting the plurality of sensor-based feature values to the prediction system. In this manner, the ambient sensing device may implement a local, configurable filtering tool to improve the customization of message filtering and reducing network traffic, energy expenditure, and data backlogs between the ambient sensing device and network connected devices.

In some embodiments, the term “configuration parameter” refers to a data parameter that defines a filtering constraint for an excursion message. A configuration parameter may be a configurable parameter that defines a parameter-level threshold range for an excursion feature parameter. In some examples, a plurality of configuration parameters may be received (e.g., downloaded, etc.) from a prediction system. The configuration parameters may include one or more signature-based threshold and/or contextual thresholds.

In some embodiments, the term “signature-based threshold” refers to a configuration parameter that defines a filtering constraint for an excursion feature parameter associated with an entity signature definition. A signature-based threshold may include one or more threshold (e.g., a minimum and/or a maximum) means and/or medians for one or more of the aggregated feature values. By way of example, the signature-based thresholds may include one or more height thresholds (e.g., aggregated height value>Hₘₐₓ (e.g., 8 ft) or <Hₘᵢₙ (e.g., 4 ft)), width thresholds (e.g., aggregated width value>Wₘₐₓ (e.g., 6 ft) or <Wₘᵢₙ (1 ft)), velocity thresholds (e.g., aggregated velocity value>Vₘₐₓ (e.g., 5.6 ft/sec) or <Vₘᵢₙ (0.2 ft/sec)), acceleration thresholds (e.g., aggregated acceleration value>Aₘₐₓ (e.g., 2 ft/sec²) or <Aₘᵢₙ (0.1 ft/sec²)), confidence thresholds (e.g., aggregated confidence value<Cₘᵢₙ (80%)), gain thresholds (e.g., aggregated gain value>Gₘₐₓ or <Gₘᵢₙ), and/or the like.

In some embodiments, the term “contextual threshold” refers to a configuration parameter that defines a filtering constraint for an excursion feature parameter associated with a defined contextual attribute. A contextual threshold may include one or more threshold (e.g., a minimum and/or a maximum) distance and/or duration measurements for the distance feature value and/or duration feature value, respectively. By way of example, the contextual threshold may include one or more total distance thresholds (e.g., distance feature value>Dₘₐₓ (e.g., 100 ft) or <Dₘᵢₙ (e.g., 1 ft)), total linear distance (e.g., Origin to endpoint>CFDₘₐₓ or <CFDₘᵢₙ), total time thresholds (e.g., duration feature value>Tₘₐₓ (e.g., 500 sec) or Tₘᵢₙ (e.g., 10 sec)), minimum percentage of human classified data points, minimum linear distance from origin (e.g., 100 cm), maximum time without moving the minimum linear distance (e.g., 12 seconds), and/or the like.

In some embodiments, the term “triggering event” refers to a data entity that triggers an excursion message. A triggering event, for example, may include an event that identifies a plurality of sensor-based feature values for an excursion message. In response to the triggering event, an ambient sensing device may generate an excursion message and provide the message to a prediction system.

In some embodiments, the term “excursion message” refers to a data entity that describes a message between an ambient sensing device and a prediction system. An excursion message, for example, may include a plurality of sensor-based feature values corresponding to an excursion event. For example, the ambient sensing device may transmit a plurality of, non-discarded, sensor-based feature values respectively corresponding to the plurality of excursion feature parameters through an excursion message. In some examples, the excursion message may include one or more device identifiers, a device location, the plurality of sensor-based feature values, and/or the like.

In some examples, the excursion message may include one or more device identifiers. The device identifier may include a unique identifier of the ambient sensing device. The device identifier, for example, may include an assigned unique identifier and/or an Internet Protocol (IP) address of the ambient sensing device. In addition, or alternatively, the excursion message may include location data associated with the ambient sensing device, such as one or more relative coordinates, a relative location tag (e.g., bedroom, kitchen, living room, hallway), and/or the like. In some examples, a device identifier may correspond to a relative location data, such that a device identifier may identify a device located within a particular relative (or global) location.

In some examples, the ambient sensing device may issue one or more heartbeat messages in addition to the excursion message. The heartbeat messages, for example, may include one or more device identifiers and may be transmitted at a heartbeat frequency (e.g., one hour, ninety minutes, etc.) to confirm a status of the ambient sensing device to the prediction system. In some examples, the heartbeat messages may enable the prediction system to push information (e.g., configuration parameters, etc.) to the ambient sensing device (e.g., over-the-air updates). By way of example, the prediction system may push heartbeat response messages that may identify one or more configuration parameters for download by the ambient sensing device.

In some embodiments, a heartbeat message comprises a replicated structure of an excursion message. A heartbeat message, for example, may include a same size and/or length of an excursion message. In some examples, the heartbeat message may include one or more device identifiers, device locations, a plurality of sensor-based feature values, and/or the like. Up to each of the message attributes may be duplicated from a prior excursion message and/or randomly generated to create a message that mirror the structure of an excursion message. In some examples, an excursion message and/or a heartbeat message may comprise a message header with one or more message flags. In some examples, a message flag (e.g., a binary single bit flag) may include an heartbeat flag that is set to differentiate the excursion message (e.g., with a “0”) from a heartbeat message (e.g., with a “1”). In this manner, a heartbeat message may simulate movement within a monitored environment to adverse parties without access to a location of the heartbeat flag.

In some examples, a heartbeat message may be emitted from the ambient sensing device at a dynamic interval to further obscure the heartbeat message from an excursion message. For example, a heartbeat message may be emitted at a random interval within a heartbeat frequency (e.g., random intervals sent at least every ninety minutes). In this manner, heartbeat messages may signal random movements within a monitored environment that may obscure the presence of the target objects within a monitored environment to adverse parties. In this manner, the ambient sensing devices may be implemented within a monitored environment without exposing the monitored environment to adverse parties (e.g., hackers intending to burglarize and empty house).

In some embodiments, the term “prediction system” refers to a computing entity that includes one or more processors and memory that are collectively configured to perform one or more operations of the present disclosure. A prediction system, for example, may include centralized, cloud-based, and/or the like server that is communicatively connected to a plurality of ambient sensing devices. The prediction system may receive a plurality excursion messages from each of the plurality of ambient sensing devices and perform one or more calibration and/or predictive operations for one or more tracking targets within a plurality of monitored environments of the plurality of ambient sensing devices.

In some examples, the one or more operations performed by the prediction system, responsive to one or more excursion messages of a respective ambient sensing device, may be based on a time period of the ambient sensing device's lifetime. For example, during one or more calibration time periods, the prediction system may perform one or more calibration operations in response to a plurality of excursion messages from an ambient sensing device. During one or more prediction time periods, the prediction system may perform one or more prediction operations in response to a plurality of excursion messages from an ambient sensing device.

In some embodiments, the term “calibration time period” refers to a temporal parameter that defines a duration of a calibration activity for an ambient sensing device. A calibration time period, for example, may include a configurable parameter that defines a setup time for an ambient sensing device after the device is installed within a monitored environment. In some examples, the calibration time period may include one or more days, weeks, and/or the like. During the calibration time period, the prediction system may receive a plurality of excursion messages from an ambient sensing device and, using the plurality of sensor-based feature values thereof, automatically establish one or more tracking target signatures for one or more tracking targets within a monitored environment. To do so, the prediction system may identify a candidate entity signature and/or one or more contextual attributes from the plurality of sensor-based features values of each of the excursion messages.

In some embodiments, the term “candidate entity signature” refers to a set of sensor-based feature values from an excursion message that correspond to an entity signature definition. A candidate entity signature, for example, may include a subset of the plurality of sensor-based feature values that correspond to the parameters of an entity signature definition. In some examples, the prediction system may generate one or more tracking target signatures for one or more tracking targets within a monitored environment. The tracking target signatures may be generated by extracting a candidate entity signature from each of a plurality of excursion messages received over a calibration time period. Once a tracking target signature is established, a candidate entity signature may be extracted from an excursion message and compared to the tracking target signature to identify a tracking target without exposing PII for the tracking target. As described herein, a tracking target signature may include a centroid mean and a standard deviation. The candidate entity signature may be compared to a tracking target signature by determining a number of standard deviations between the subset of the plurality of sensor-based feature values of the excursion message and the centroid mean (e.g., establishing a subset of a plurality of sensor-based feature values for a tracking target) in a multidimensional parameter space. In some examples, a match probability (e.g., 90% within 2 standard deviations, 75% within 3 standard deviations, 50% within 4 standard deviations, etc.) may be generated based on the number of standard deviations. In some examples, a match between the candidate entity signature and a tracking target signature may be generated if the match probability achieves a configurable threshold (e.g., 75%, etc.).

In some embodiments, the term “contextual attribute” refers to a sensor-based feature value from an excursion message that corresponds to a defined contextual attribute. A contextual attribute, for example, may identify an activity level associated with an excursion event. By way of example, a contextual attribute may be reflective of a velocity, total distance, and/or time of an excursion event. In some examples, a contextual attribute may be leveraged to generate a tracking target signature and/or one or more predictive features for a tracking target signature.

In some embodiments, the term “candidate entity cluster” refers to a multi-dimensional datapoint that describes a candidate entity signature from an excursion message received during a calibration time period. For example, during a calibration time period, a prediction system may receive an excursion message, extract a candidate entity signature from the excursion message, and map the candidate entity signature to a multi-dimensional space. By way of example, each candidate entity signature may be mapped to a multi-dimensional space based on at least two of the aggregated height value, aggregated width and/or girth value(s), aggregated velocity value, aggregated total distance value, aggregated acceleration value, aggregated gain value, aggregated tracking error variance value, aggregated group variance value, and/or the like. The candidate entity signature may be mapped to the multi-dimensional space with a plurality of candidate entity signatures received during the calibration time period. Once mapped, a point clustering model may be leveraged to generate a plurality of candidate entity clusters based on the mapped values of each of the plurality of candidate entity signatures. For each cluster, a centroid mean and standard deviation may be generated by aggregating the mapped values of each of a subset of candidate entity signatures within the candidate entity cluster.

In some embodiments, the term “point clustering model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A point clustering model may include any type of model configured, trained, and/or the like to generate one or more candidate entity clusters from a plurality of multi-dimensional datapoints received during a calibration time period. In some examples, the point clustering model may include a multi-dimensional k-means clustering model. In some examples, k may be a configurable parameter that may be set based on an anticipated number of tracking targets within a monitored environment.

In some embodiments, the term “candidate target parameter value” refers to a data value that describes a cluster-level sensor-based feature value for a tracking target selection parameter. For example, the tracking target selection parameter may be defined based on selection criteria for a tracking target signature from a plurality of candidate entity clusters. In some examples, the candidate target parameter value may include an aggregated velocity value for a candidate entity cluster. By way of example, a prediction system may generate a mean and standard deviation for a velocity feature value across each of a subset of excursion messages associated with a candidate entity cluster. In some examples, a tracking target signature may be selected as the slowest (e.g., lowest velocity feature value, etc.) candidate entity cluster. In some examples, multiple tracking target signatures may be selected for a monitored environment to ensure that the activity of a single designated tracking target is captured within the monitored environment. For example, a primary tracking target signature may be selected for a primary tracking target based on the slowest (e.g., lowest velocity feature value, etc.) candidate entity cluster. In addition, or alternatively, a secondary tracking target signature may be selected for a secondary tracking target based on a next slowest (e.g., second lowest velocity feature value, etc.) candidate entity cluster.

In some embodiments, the term “primary tracking target” refers to a tracking target that is associated with a lowest candidate target parameter value.

In some embodiments, the term “secondary tracking target” refers to a tracking target that is associated with a second lowest candidate target parameter value.

In some embodiments, the term “tracking target signature” refers to an entity signature of a tracking target. A tracking target signature, for example, may include a baseline activity signature that is automatically generated during a calibration time period for a tracking target. By way of example, during the calibration time period, the prediction system may establish a baseline activity signature for a tracking target (e.g., a household occupant, etc.) for an ambient sensing device. Subsequent to the calibration time period, an entity signature may be compared to the tracking target signature to match an excursion message to a tracking target without using personally identifiable information for the tracking target.

In some examples, a tracking target signature may include one or more centroid and/or standard deviation values for a tracking target. The centroid and/or standard deviation values, for example, may correspond to a candidate entity cluster associated with the tracking target signature. For example, the centroid and/or standard deviation values may be generated by aggregating the feature values of each of a subset of candidate entity signatures within the candidate entity cluster associated with the tracking target signature.

In some embodiments, the term “target log file” refers to a data structure that stores a plurality of historical contextual attributes for a tracking target. A target log file, for example, may correspond to a tracking target signature and may store a plurality of historical contextual attributes received from excursion messages that include a matching entity signature. In this manner, a target log file may be maintained for a tracking target without exposing personally identifiable information of the tracking target.

In some embodiments, the term “historical contextual attribute” refers to a data value that describes a recorded contextual attribute for a tracking target. A historical contextual attribute, for example, may include a contextual attribute from an excursion message that includes an entity signature that matches a tracking target signature of the tracking target.

In some embodiments, the term “temporal assessment trigger event” refers to a data entity that triggers the performance of one or more predictive operations of the present disclosure. A temporal assessment trigger event, for example, may include temporal trigger that executes at a defined frequency. The defined frequency may be configurable based on the monitored environment. In some examples, the defined frequency may include a daily frequency. For example, the temporal assessment trigger event may execute each morning. Responsive to the temporal assessment trigger event, a plurality of predictive feature may be generated for one or more evaluation time intervals from the time of the temporal assessment trigger event.

In some embodiments, the term “evaluation time interval” refers to a temporal parameter that defines a duration of predictive activity for a predictive feature. An evaluation time interval, for example, may be one of a plurality of evaluation time intervals that each define a period of activity that may be predictive of a prediction output. For instance, the plurality of evaluation time intervals may include a one-day time interval, a three-day time interval, a seven-day time interval, and/or the like.

In some embodiments, the term “predictive feature” refers to a data value that describes an engineered feature for a predictive model. A predictive feature, for example, may include one of a plurality of predictive features extracted from a plurality of historical contextual attributes of a target log file for a tracking target. Each predictive feature may reflect a statistical measure of activity for the tracking target over a period of time. By way of example, some of the predictive features may include (i) a total aggregated (e.g., a mean, standard deviation, median, etc.) velocity feature value across all of the historical contextual attributes, (ii) a 24-hour total distance of the historical contextual attributes, (iii) a prior day's aggregated (e.g., mean, standard deviation, median, etc.) velocity feature value minus the total aggregate velocity feature value, (iv) a prior day's aggregated (e.g., mean, standard deviation, median, etc.) total distance minus the 24-hour total distance, (v) a three-day aggregate (e.g., a mean, standard deviation, median, etc.) velocity feature value minus the total aggregate velocity feature value, (vi) a three-day aggregate (e.g., a mean, standard deviation, median, etc.) total distance minus the 24-hour total distance, (vii) a seven-day aggregate (e.g., a mean, standard deviation, median, etc.) velocity feature value minus the total aggregate velocity feature value, (viii) a seven-day aggregate (e.g., a mean, standard deviation, median, etc.) total distance minus the 24-hour total distance, (ix) a seven-day aggregate (e.g., a mean, standard deviation, median, etc.) velocity feature value minus a two-day aggregate velocity feature value, (x) a seven-day aggregate (e.g., a mean, standard deviation, median, etc.) total distance minus a two-day total distance, (xi) a seven-day aggregate (e.g., a mean, standard deviation, median, etc.) velocity feature value minus the three-day aggregate velocity feature value, (xii) a seven-day aggregate (e.g., a mean, standard deviation, median, etc.) total distance minus the three-day total distance, (xiii) the aggregate velocity feature value of the tracking target signature minus the three-day aggregate velocity feature value, (xiv) the total distance feature value of the tracking target signature minus the three-day total distance, and/or the like.

In some examples, the predictive features may include activity features, as outlined above. In some examples, up to each of the activity features may be normalized by dividing distance by a baseline standard deviation. In addition, or alternatively, the predictive features may include a plurality of complementary features, such as sleep features, auditory features, tactile features, and/or the like. For example, in addition to a plurality of excursion messages, a prediction system may receive a plurality of complementary messages for a tracking target. The sleep event messages may be leveraged to generate a plurality of complementary features.

In some embodiments, the term “complementary message” refers to a data entity that describes a message between a complementary ambient sensing device and a prediction system. A complementary ambient sensing device, for example, may include a sensing device within and/or otherwise associated with a monitored environment that is configured to generate sensor data that complements the sensor data of the ambient sensing device. For instance, the complementary ambient sensing device may include an audio device (e.g., microphones, etc.), tactile device (e.g., pressure sensors, etc.), and/or the like. In some examples, the complementary ambient sensing device may include a sleep sensing device, such as a sleep mat sensor (e.g., Withing Sleep Mat, etc.), that may transmit a plurality of complementary messages reflective of a plurality of complementary sensor-based feature values for a tracking target.

In some embodiments, the term “complementary sensor-based feature value” refers to a data value that is measured by a complementary ambient sensing device and reflects a characteristic of a complementary event that complements an excursion event. A complementary sensor-based feature value, for example, may include a sleep score (e.g., 1-100, etc.), an average resting heart rate, an average resting respiratory rate, and/or the like.

In some embodiments, the term “complementary feature parameter” refers to data parameter that describes a feature value of interest for complementing an excursion event. A complementary feature parameter, for example, may include a predefined parameter that describes a measurement from a complementary sensing device. The complementary feature parameters, for example, may include a sleep score parameter, a resting heart rate parameter, a resting respiratory rate parameter, and/or the like.

In some examples, a plurality of complementary feature parameters may be leveraged to generate a plurality of complementary features for a predictive model. By way of example, after baseline parameters are established (e.g., during a calibration time period), the number of standard deviations (e.g., the distance from the mean for the parameter, divided by the baseline standard deviation for that parameter) for a tracking target may be generated for a tracking target's (i) a sleep score, (ii) an average resting heart rate, (iii) an average resting respiratory rate, (iv) a prior day's sleep score minus the sleep score, (v) a prior day's average resting heart rate minus the average resting heart rate, (vi) a prior day's average resting respiratory rate minus the average resting respiratory rate, (vii) a mean of a past three day's sleep score minus the sleep score, (viii) a mean of the past three day's average resting heart rate minus the average resting heart rate, (ix) a mean of past three day's average resting respiratory rate minus the average resting respiratory rate, (x) a mean of past seven day's sleep score minus sleep score, (xi) a mean of past seven day's average resting heart rate minus the average resting heart rate, (xii) a mean of past seven day's average resting respiratory rate minus the average resting respiratory rate, (xiii) a mean of past seven day's sleep score minus the mean of a past two day's sleep score, (ix) a mean of past seven day's average resting heart rate minus the mean of a past two day's average resting heart rate, (x) a mean of past seven day's average resting respiratory rate minus the mean of the past two day's average resting respiratory rate, (xi) a mean of past seven day's sleep score minus the mean of past three day's sleep score, (xii) a mean of past seven day's average resting heart rate minus the mean of past three day's average resting heart rate, (xiii) a mean of past seven day's average resting respiratory rate minus mean of past three day's average resting respiratory rate, (xiv) a baseline sleep score minus the mean of past three day's sleep score, (xv) a baseline average resting heart rate minus mean of past three day's average resting heart rate, (xvi) a baseline average resting respiratory rate minus the mean of past three day's average resting respiratory rate, and/or the like.

In some embodiments, the term “predictive model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A predictive model may include any type of model configured, trained, and/or the like to generate a predictive output based on a plurality of predictive features. A predictive model may include one or more of any type of machine learning model including one or more supervised, unsupervised, semi-supervised, reinforcement learning models, and/or the like. In some examples, the predictive model may include a plurality of statistical and/or machine learning models.

By way of example, a predictive model may include a regression model that is configured to receive a plurality of predictive features and perform a regression analysis to identify correlations between the predictive features and one or more target outputs (e.g., 1-3 day emergency room visits, 1-2 week emergency room visits, etc. in a clinical example). By way of example, the regression model may include a linear regression model, a polynomial regression model, a multiple regression model, a ridge regression model, and/or the like. In some examples, the regression model may be configured (e.g., trained, etc.) with a plurality of historical positive and negative training pairs that match a plurality of historical predictive features to a positive target output and/or a negative target output, respectively. In some examples, a tracking target may be monitored for a positive and/or negative outcome and the plurality of predictive features may be added to the plurality of historical positive and negative training pairs with a positive target output label and/or a negative target output label reflective of the positive and/or negative outcome. In this manner, the predictive model may learn over time based on real world data.

In some embodiments, the term “predictive output” refers to a data value that describes an output of a predictive model. A predictive output, for example, may include a weighted regression score that identified a probability of a positive and/or negative outcome for a tracking target. In some examples, a predictive output may be compared to an action threshold and, in response to the predictive output satisfying the action threshold, a prediction-based action may be initiated. The prediction-based action, for example, may include one or more alerts to a tracking target, an agent (e.g., robotic agent, human agent, etc.) for the tracking target, and/or the like. In some examples, the alert may be an auditory and/or visual alert emitted by the ambient sensing device.

### IV. OVERVIEW

Various embodiments of the present disclosure provide improved ambient sensing techniques that optimize processing and memory usage, reduce network traffic, and enhance privacy within a monitored environment. Some embodiments of the present disclosure provide a multi-device configuration that includes a sensing device and a network connected prediction system. The sensing device includes a local filtering mechanism that locally processes and filters sensor data based on a relevance of the sensor data to a predictive task. The filtered sensor data is provided to a prediction system that leverages traditionally anonymous features within the sensor data to automatically calibrate the sensing device with respect to one or more tracking targets within the monitored environment. Once calibrated, the sensing device may continuously filter and provide anonymous sensor data to the prediction system, which may leverage the anonymous sensor data to identify and track the activity of the one or more tracking targets without explicit knowledge of their identities. In this way, messages within the multi-device configuration are reduced; thereby, resulting in less processing and memory resource expenditures. Meanwhile, the filtered data that is provided between devices lacks the information that is traditionally misused by malicious parties.

In some embodiments of the present disclosure, the multi-device configuration enables local filtering of sensor data before data transmissions between a sensing device and a network connected prediction system. Traditionally, continuously monitored environments are monitored using sensing devices that collect and forward a continuous stream of sensor data to network connected devices for processing. Such configurations require a constant network connection, or robust memory resources for locally storing sensor data between transmissions. By locally filtering sensor data, some techniques of the present disclosure reduce hardware memory requirements on the sensing device by limiting an amount of sensor data temporarily stored at the device. The local filtering technique also limits data transmissions between network connected devices, which leads to less network congestion and enables the use of the multi-device configuration within monitored environments with stricter bandwidth constraints (e.g., households with limited WiFi service, limited cellular data plans, etc.). As a result, the multi-device configuration of the present disclosure improves the efficiency of monitoring an environment, while increasing the applicability of the technology to new, low-bandwidth environments.

In some embodiments, the network connected devices may implement automated calibration and prediction techniques for processing pre-filtered data transmissions to track activities within an environment. The automated calibration technique, for example, may use a clustering model to cluster features extracted from sensor data into distinguishable clusters representative of different entities within a monitored environment. These clusters may be used to generate tracking target signatures that may replace traditional signatures derived from an entity's PII or recognizable facial features. By doing so, the calibration techniques enable an automated solution to the remote calibration of sensing devices that replaces traditionally unsecure signatures with anonymous signatures. This provides enhanced security by reducing exposure to network attacks, while allowing the ambient tracking of activity within an environment.

For example, some of the tracking techniques of the present disclosure may leverage tracking target signatures that identify targets within an environment based on point cloud features. Unlike traditional PII-based features, the point cloud features are unusable outside the scope of a particular predictive task. In this way, the tracking techniques of the present disclosure leverage sensor data within pre-filtered data transmissions to track activity within an environment without exposing its occupants to privacy risks.

Examples of technologically advantageous embodiments of the present disclosure include: (i) improved cross-device networking techniques, (ii) improved calibration techniques, (iii) improved sensor-based tracking techniques, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to computing networks and sensor-based technology. In particular, systems and methods are disclosed herein that implement a local filtering technique that may be used to improve the capabilities of sensing devices within a monitored environment. Moreover, systems and methods are disclosed herein that leverage pre-filtered sensor data to calibrate and then track targets within a monitored environment without exposing PII of the targets. By doing so, some of the techniques of the present disclosure may improve sensing technology by reducing privacy risks, while reducing processing and memory resources traditionally required for such tasks.

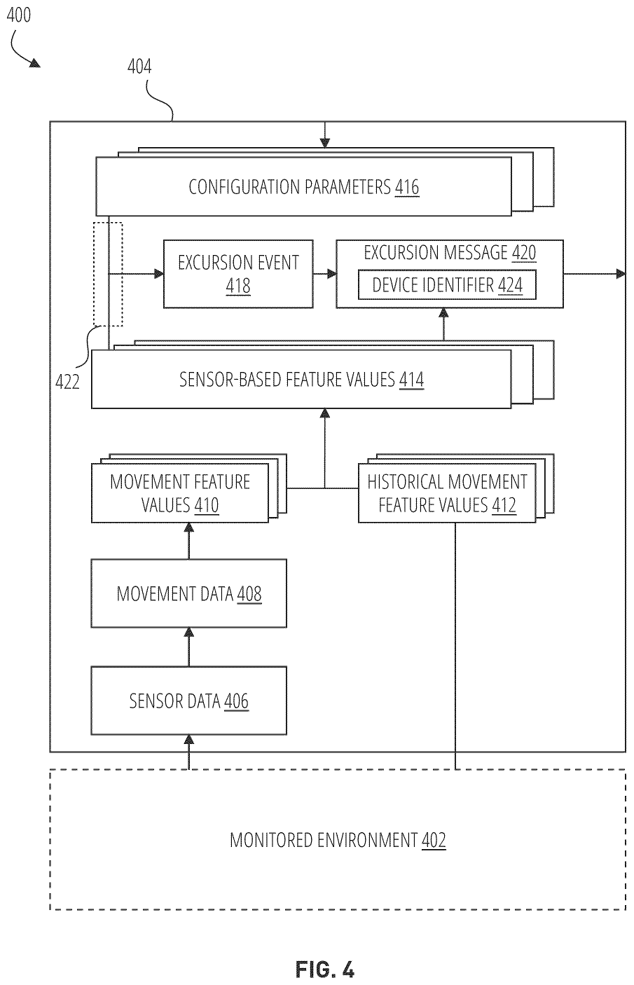

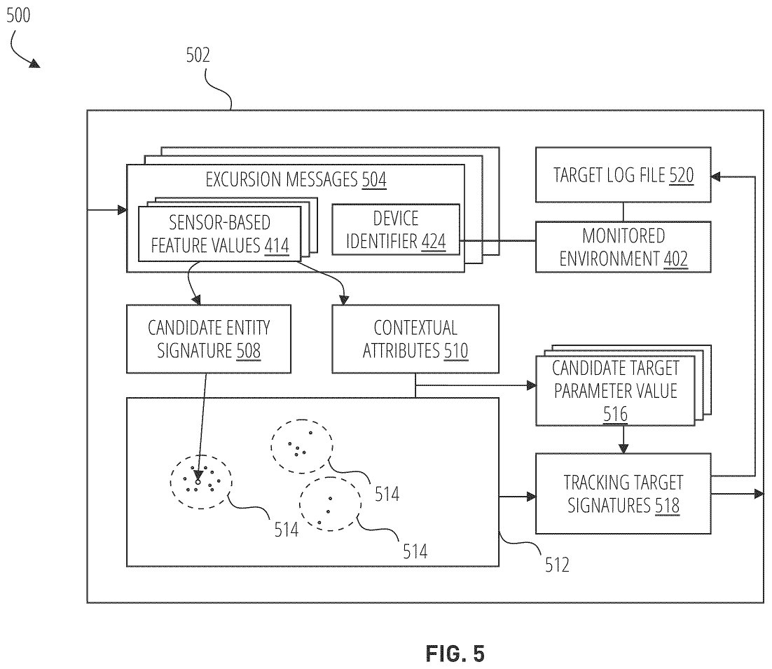

FIG. 4 is an example data flow diagram 400 of a local sensor filtering technique in accordance with some embodiments discussed herein. The local sensor filtering technique, for example, may be performed to filters communications transmitted by an ambient sensing device 404 for a monitored environment 402. As depicted, a local filter mechanism 422 may be applied to sensor data 406 received by the ambient sensing device 404 to identify excursion events 418 represented by the sensor data 406 and, responsive to the excursion event 418, generate and transmit an excursion message 420. By doing so, an ambient sensing device 404 may apply a local filter to sensor data 406 to reduce data transmissions between the ambient sensing device 404 and remote systems, such as prediction system as described with reference to FIG. 5. This, in turn, reduces communication constraints traditionally required to continuously facilitate a monitored environment 402. Moreover, by applying the local filter mechanism 422, the ambient sensing device 404 may detect and proactively discard irrelevant data that traditionally leads to wasted processing and memory resources.

In some embodiments, sensor data 406 is received from a monitored environment 402. The sensor data 406, for example, may be received using a radar sensor of an ambient sensing device 404 positioned within the monitored environment 402. The radar sensor, for example, may be configured with the ambient sensing device 404. In some examples, the sensor data 406 may be received by emitting a plurality of radar signals within a monitored environment 402 associated with one or more tracking targets. In some examples, the plurality of radar signals may be emitted at a reporting time interval.

In some embodiments, the ambient sensing device 404 is a computing entity that includes one or more sensors, one or more processors, and memory that are collectively configured to perform one or more operations of the present disclosure. An ambient sensing device 404, for example, may include a housing, a mounting bracket, and one or more electrical components placed at least partially within the housing. The one or more electrical components, for example, may include a radar sensor, an onboard microchip (e.g., a logic chip, a memory chip, system-on-a-chip, application-specific integrated chip (ASIC), etc.) electrically connected to the radar sensor, one or more communication interfaces, and/or one or more interactive elements.

The microchip, for example, may include one or more integrated memory components configured to provide local, on-chip memory storage for the ambient sensing device 404. In addition, or alternatively, the microchip may include one or more integrated processing components configured to locally process data stored in on-chip memory. In some examples, the one or more communication interfaces may include one or more wireless network interfaces, such as one or more Wi-Fi interfaces, Bluetooth interfaces, and/or the like. The one or more interactive elements may include one or more push buttons, lights, screens, microphones, speakers, and/or the like. By way of example, the one or more interactive elements may include three different colored lights that may be used for troubleshooting when there is, for instance, a communication issue. In addition, or alternatively, the one or more interactive elements may be activated in response to a predictive output, as described herein.

In some examples, computer-readable instructions may be locally stored in on-chip memory of the ambient sensing device 404 that, when locally executed by the one or more processors of the ambient sensing device 404, may cause the ambient sensing device 404 to perform one or more operations of the present disclosure. By way of example, the ambient sensing device 404 may include one or more tracking components, such as TI 3D people tracking software that may locally process sensor data 406 to identify objects (and/or point clouds thereof) within a monitored environment 402, extract movement data 408 reflective of the objects, and report the movement data 408 at a reporting time interval.

In some examples, the ambient sensing device 404 may be mounted within a monitored environment 402 using a mounting bracket. The mounting bracket, for example, may include an adhesive material, a wall mount bracket, and/or the like. As described herein, one or more ambient sensing devices 404 may be mounted within a monitored environment 402 to generate movement data 408 for one or more active entities within the monitored environment 402.

In some embodiments, the radar sensor is sensing component of an ambient sensing device 404. A radar sensor, for example, may include a pulse radar, a continuous wave radar, a frequency-modulated continuous wave radar, a deep dive continuous wave radar, and/or the like. In some examples, the radar sensor may include a millimeter wave radar sensor, such as one or more TI mmWave radar sensors.

In some embodiments, the sensor data 406 includes sensor signals received using the radar sensor. The sensor data 406, for example, may include RF signals that are received by the radar sensor and converted (e.g., using ADCs, etc.) to a digital representation of the RF signals. In some examples, the sensor data 406 may reflect one or more candidate movements with a monitored environment 402 by mapping the monitored environment 402 at a particular frequency and comparing the mapped monitored environment 402 to a base environment map. For example, the sensor data 406 may include one or more protrusions or anomalies that conflict with a base environment map and may be reflective of a candidate movement of an object within the monitored environment 402.

In some embodiments, the reporting time interval is a data parameter that defines a reporting frequency of a radar sensor. The reporting time interval may be a configurable parameter. In some examples, the reporting time interval may include a tenth of a second interval.

In some embodiments, the monitored environment 402 is an environment that includes an ambient sensing device 404. A monitored environment 402 may depend on a prediction domain and/or a use case for an ambient sensing device 404. For example, a monitored environment 402 may include one or more rooms, hallways, and/or the like, within a facility (e.g., a secured facility, etc.), a housing unit, and/or another indoor environment. In addition, or alternatively, a monitored environment 402 may include one or more yards, alleys, ingress/egress ways, and/or the like, within an outdoor environment. In some examples, with reference to a clinical prediction domain, a monitored environment 402 may include a portion of a housing unit in which a monitored patient resides.

In some embodiments, movement data 408 is generated based on the sensor data 406. For example, the movement data 408 may be generated using the radar sensor. The movement data 408 may be reflective of a candidate movement for one or more tracking targets within the monitored environment 402.

In some embodiments, the tracking target is an entity that is expected to move within a monitored environment 402. A tracking target may depend on a prediction domain and/or a use case for an ambient sensing device 404. For example, a tracking target may include person, animal, and/or object (e.g., robot, equipment, etc.) that visits, resides in, works in, has a security clearance for, and/or otherwise moves within a monitored environment 402. In addition, or alternatively, a tracking target may include a person, animal, and/or object (e.g., robot, equipment, etc.) that is prohibited from a monitored environment 402 (e.g., a banned individual, etc.). In some examples, returning to the clinical prediction domain example, a tracking target may include a monitored patient.

In some embodiments, the movement data 408 is point cloud data associated with a candidate movement. The point cloud data, for example, may be extracted from sensor data 406 received over a reporting time interval. For example, the point cloud data may include a three-dimensional point cloud reflective of an object and a candidate movement within a monitored environment 402.

In some embodiments, a plurality of movement feature values 410 is generated based on the movement data 408. In some examples, the movement feature values 410 may be generated based on a plurality of excursion feature parameters associated with (a) an entity signature definition and/or (b) one or more defined contextual attributes. The plurality of movement feature values 410, for example, may include a first movement subset that corresponds to the entity signature definition and/or a second movement subset that corresponds to the one or more defined contextual attributes.

In some embodiments, a movement feature value is a data value that is extracted from movement data 408. The movement feature values 410, for example, may include attributes of a three-dimensional point cloud, such as a point cloud height, a point cloud width and/or girth, a point cloud's centroid location, point cloud velocity, a point cloud acceleration, a point cloud confidence level, a point cloud gating function gain, a point cloud tracking error variance, a point cloud group variance, and/or any other metadata extracted from movement data 408. In some examples, a plurality of movement feature values 410 may be extracted from movement data 408 for each of a plurality of excursion feature parameters. By way of example, a point cloud height (e.g., object height) may be extracted for an aggregated height parameter, a point cloud width and/or girth (e.g., object width and/or girth) may be extracted for an aggregated width and/or girth parameter(s), a point cloud's centroid location (e.g., object's three dimensional location in X, Y, Z coordinates) may be extracted for a location parameter, point cloud velocity (e.g., object's three dimensional velocity in X, Y, Z directions) may be extracted for an aggregated velocity parameter, a point cloud acceleration velocity (e.g., object's three dimensional acceleration in X, Y, Z directions) may be extracted for an aggregated acceleration parameter, a point cloud confidence level (e.g., probability between 0 and 1) may be extracted for an aggregated confidence parameter, a point cloud gating function gain (e.g., an amount an object's point cloud may grow that be set based on expected tracking errors, expected target maneuvers, uncertainties in the detection layer, etc.) may be extracted for an aggregated gain parameter, a point cloud tracking error variance (e.g., covariance matrix showing variance of location and velocity predictions vs. reality between frames, which are the four values in the diagonal in the covariance matrix) may be extracted for an aggregated tracking error variance parameter, a point cloud group variance (e.g., covariance matrix showing variance of location and velocity of the point cloud over time, which are the four values in the diagonal in the covariance matrix) may be extracted for an aggregated group variance parameter, and/or any the like.

In some examples, a plurality of movement feature values 410 may be extracted from movement data 408 for each of a plurality of sequential candidate movements. Each of the plurality of sequential candidate movements, for example, may be associated with movement data 408 reported at a particular reporting time of a reporting time interval. In some examples, an object identifier may be generated to track the movement of an object across multiple reporting times of a reporting time interval. For example, in response to receiving movement data at a first reporting time, a plurality of movement feature values 410 may be extracted from the movement data 408 and compared to a plurality of historical movement feature values 412 extracted at one or more reporting times before the first reporting time. In response to a match, an object identifier assigned to the plurality of historical movement feature values 412 may be assigned to the plurality of movement feature values 410. Otherwise, a new object identifier may be generated and assigned to the plurality of movement feature values 410. In this manner, a sequence of movement feature values 410 may be tracked and aggregated over one or more reporting times to generate a plurality of sensor-based feature values 414 respectively corresponding to the plurality of excursion feature parameters.

In some embodiments, an excursion feature parameter is data parameter that describes a feature value of interest for an excursion event. An excursion feature parameter, for example, may include a predefined parameter that describes a measurement from movement data 408 received over a sequence of candidate movements. In some examples, an excursion feature parameter may include an aggregated feature parameter, a distance parameter, a time parameter, among others. By way of example, a plurality of excursion feature parameters may include: (i) an aggregated height parameter defining a mean, standard deviation, or median point cloud height across a sequence of point clouds, (ii) an aggregated width and/or girth parameter(s) defining a mean, standard deviation, or median point cloud width across a sequence of point clouds, (iii) a distance feature parameter defining a distance travelled from a first point cloud to a last point cloud in the sequence of point clouds, (iv) a duration feature parameter defining a time between a first point cloud and a last point cloud in the sequence of point clouds, (v) an aggregated velocity parameter defining a mean, standard deviation, or median point cloud velocity, (vi) an aggregated acceleration parameter defining a mean, standard deviation, or median point cloud acceleration, (vii) an aggregated confidence parameter defining a mean, standard deviation, or median point cloud confidence level, (viii) an aggregated gain parameter defining a mean, standard deviation, or median point cloud gating function gain, (ix) an aggregated tracking error variance parameter defining a mean, standard deviation, or median point cloud tracking error variance, (x) an aggregated group variance parameter defining a mean, standard deviation, or median point cloud group variance, and/or any other configurable parameter.

In some embodiments, an entity signature definition is a set of excursion feature parameters that is reflective of a tracking target's identity within a tracking system. An entity signature definition, for example, may include a plurality of point cloud attributes that may be used to identify a tracking target without PII, such as a name, facial features, and/or the like. In some examples, an entity signature definition may include semi-static feature parameters that are not expected to deviate over time. By way of example, an entity signature definition may include two or more of (i) the aggregated height parameter, (ii) the aggregated width and/or girth parameter(s), (iii) the aggregated velocity parameter, (iv) the aggregated acceleration parameter, (v) the aggregated confidence parameter, (vi) the aggregated gain parameter, (vii) the aggregated tracking error variance parameter, and/or (viii) the aggregated group variance parameter.

In some embodiments, the defined contextual attributes are a set of excursion feature parameters that are reflective of a tracking target's activity level within a monitored environment 402. A defined contextual attribute, for example, may include activity data that may be used to characterize a level of a tracking target's activity over time. In some examples, a defined contextual attribute may include dynamic feature parameters that are expected to deviate over time. By way of example, a defined contextual attribute may include an aggregated velocity parameter, a distance feature parameter, and/or a duration feature parameter.

In some embodiments, a plurality of sensor-based feature values 414 is generated for an excursion event 418 based on the plurality of movement feature values 410 and a plurality of historical movement feature values 412.

In some examples, the sensor-based feature values 414 may be generated by generating a plurality of aggregated feature values that respectively correspond to a first parameter subset of the plurality of excursion feature parameters associated with the entity signature definition. The plurality of aggregated feature values, for example, may be generated by aggregating the first movement subset with a first historical movement subset of the plurality of historical movement feature values 412. By way of example, a first movement feature value may be identifier from the first movement subset that corresponds to an excursion feature parameter. A plurality of second movement feature values may be identified from the first historical movement subset that corresponds to the excursion feature parameter. The aggregated feature value may be generated for the excursion feature parameter by aggregating the first movement feature value and the plurality of second movement feature values.

In some examples, the second movement subset may include a location value and a time value, and the one or more defined contextual attributes may define a distance feature parameter and a duration feature parameter. A distance feature value may be generated that corresponds to the distance feature parameter based on a comparison between (a) the location value and (b) an origin location value of the plurality of historical movement feature values 412. In addition, or alternatively, a duration feature value corresponding to the duration feature parameter may be generated based on a comparison between (a) a time value and (b) an origin time feature value of the plurality of historical movement feature values 412.

In some embodiments, the sensor-based feature values 414 are data values that are measured from one or more movement feature values 410 and reflect a characteristic of a potential excursion event 418. The sensor-based feature values 414, for example, may include data values for respective excursion feature parameters. The sensor-based feature values 414 may include aggregated feature values, a distance feature value, and/or a duration feature value depending on the excursion feature parameter.

An aggregated feature value, for example, may include a mean, standard deviation, median, and/or any other aggregation of a plurality of movement feature values 410 for a particular excursion feature parameter.

A distance feature value may be a distance measurement between a plurality of location measurements (e.g., a point clouds' centroid locations) of the plurality of movement feature values 410. For example, a distance feature value may include a straight line, three-dimensional distance measurement between a first location measurement and a last location measurement in a sequence of location measurements. In addition, or alternatively, the distance feature value may include a summation of a plurality of three-dimensional distance measurements between each sequential pair of location measurements in a sequence of location measurements. In some examples, a distance feature value may include a horizontal plan (X,Y) two-dimensional distance measurement between a first location measurement and a last location measurement in a sequence of location measurements.

A duration feature value may be a temporal measurement between a plurality of time measurements (e.g., a point cloud times) of the plurality of movement feature values 410. For example, the duration feature value may include a temporal measurement between a first-time measurement and a last time measurement in a sequence of time measurements. By way of example, a duration feature value may include a time measurement between a creation time of a new object identifier and a termination time of the object identifier at which movement data 408 is no longer received for the object identifier.

In some embodiments, the excursion event 418 is a sequence of candidate movements that satisfy excursion event criteria. An excursion event 418, for example, may be detected based on a comparison of a plurality of sensor-based feature values 414 generated for a sequence of candidate movements to excursion event criteria. In some examples, the plurality of sensor-based feature values 414 may be continuously generated and/or updated, locally by the ambient sensing device 404, until a triggering event occurs responsive to the plurality of sensor-based feature values 414 satisfying the excursion criteria. In some examples, an excursion message 420 may be initiated from the ambient sensing device 404 in response to the triggering event. In this way, the ambient sensing device 404 may leverage excursion event criteria to filter communications between the ambient sensing device and network connected systems.

In some embodiments, the sensor-based feature values 414, including a distance feature value, are derived from a plurality sub-excursion feature values to incrementally measure aggregated features within an excursion event, while accounting for cyclical and/or paused movement patterns. For example, an excursion event may include a sequence of candidate movements, aggregated into sub-excursions, that each include a portion of a minimum linear distance (e.g., starting at a position at which an object identifier is created and ending at a position at which the tracking target corresponding to the object identifier stops existing), excluding paused readings when the tracking target has stopped movement progression as defined, for example, by not moving a minimum candidate movement distance within a maximum waiting period of time. By excluding these paused readings, outliers may be removed that traditionally decrease the accuracy of distance and velocity measurements across an excursion event.

In some examples, each candidate movement may include a starting location and an ending location. A first candidate movement may begin after a tracking target has reached a minimum candidate movement distance (e.g., 1 meter) from a starting location, and continues until the tracking target has moved another iteration of the minimum candidate movement distance (e.g., in any direction) within a maximum waiting period of time (e.g. 12 seconds), thereby starting a first sub-excursion. For example, a candidate movement may start after a tracking target moves a first iteration of the minimum candidate movement distance (e.g., excluding an initial iteration) and may end after moving a second iteration of the minimum candidate movement distance, creating a sub-excursion consisting of both of those iterations. In the event that the tracking target does not move the minimum candidate movement distance within a maximum waiting period of time, the candidate movement may be discarded or voided, and the sub-excursion will be completed. In response to a voided candidate movement, the next candidate movement may start after the tracking target moves another iteration of the minimum candidate movement distance (e.g., excluding an initial iteration), thereby starting a new sub-excursion. In this way, a plurality of candidate movements may be recorded with equal distance measurements, while excluding outlier candidate movements during which a tracking target may be making non-ambulation movements or may be paused. An excursion event becomes the aggregation of the sub-excursions created by the tracking target's movements. In some examples, the plurality of sensor-based feature values 414 of the present disclosure may be determined based on the feature values from each of the candidate movements within an excursion event.

In some embodiments, a triggering event is identified based on a comparison between the plurality of sensor-based feature values 414 and excursion event criteria. The excursion event criteria, for example, may include a plurality of configuration parameters 416. In some examples, the triggering event may be identified by applying a local filter mechanism 422 to the sensor-based feature values 414. In some examples, the excursion event criteria may include one or more signature-based thresholds that each define a particular threshold range for a particular aggregated feature value of the plurality of aggregated feature values. In addition, or alternatively, the excursion event criteria may include one or more contextual thresholds that include a distance threshold defining a minimum travel distance and a maximum travel distance for the excursion event 418 and/or a time threshold defining by a minimum movement time and a maximum movement time for the excursion event 418. In addition, alternatively, one or more tracking target signatures are received from the prediction system that respectively correspond to one or more tracking targets. The one or more signature-based thresholds may be modified based on the one or more tracking target signatures 518.

In some embodiments, the triggering event is a data entity that triggers an excursion message 420. A triggering event, for example, may include an event that identifies a plurality of sensor-based feature values 414 for an excursion message 420. In response to the triggering event, the ambient sensing device 404 may generate the excursion message 420 and provide the message to a prediction system. The triggering event, for example, may be generated in response to the plurality of sensor-based feature values 414 satisfying excursion event criteria.

In some embodiments, the excursion event criteria are a set of message filtering constraints, applied by a local filter mechanism 422, that define local message criteria for providing an excursion message 420 to a prediction system. The excursion event criteria, for example, may include a plurality of configuration parameters 416 that respectively define parameter-level criteria for establishing a triggering event at the ambient sensing device 404. In some examples, the ambient sensing device 404 may continuously generate a plurality of sensor-based feature values 414 for an object identifier until a termination time of the object identifier (e.g., when the movement data 408 does not include data for the object identifier for a threshold number of reporting times of a reporting time interval). In the event that the plurality of sensor-based feature values 414 satisfies the excursion event criteria, a triggering event may be established for the plurality of sensor-based feature values 414. Otherwise, the plurality of sensor-based feature values 414 may be discarded without transmitting the plurality of sensor-based feature candidate target parameter values 516 to the prediction system. In this manner, the ambient sensing device 404 may implement a local, configurable filtering tool (e.g., the local filter mechanism 422) to improve the customization of message filtering and reducing network traffic, energy expenditure, and data backlogs between the ambient sensing device 404 and network connected devices.

In some embodiments, the configuration parameters 416 are received from a prediction system 502. For example, one or more configuration parameters may be received from the prediction system and the one or more contextual thresholds may be modified based on the one or more configuration parameters.

In some embodiments, the configuration parameters 416 include data parameters that define a filtering constraint for an excursion message 420. The configuration parameters 416 may be a configurable parameter that define a parameter-level threshold ranges for an excursion feature parameter. In some examples, a plurality of configuration parameters 416 may be received (e.g., downloaded, etc.) from a prediction system. The configuration parameters 416 may include one or more signature-based threshold and/or contextual thresholds.

In some embodiments, the signature-based thresholds are configuration parameters 416 that define a filtering constraint for excursion feature parameter associated with an entity signature definition. A signature-based threshold may include one or more threshold (e.g., a minimum and/or a maximum) means and/or medians for one or more of the aggregated feature values. By way of example, the signature-based thresholds may include one or more height thresholds (e.g., aggregated height value>Hₘₐₓ (e.g., 8 ft) or <Hₘᵢₙ (e.g., 4 ft)), width thresholds (e.g., aggregated width value>Wₘₐₓ (e.g., 6 ft) or <Wₘᵢₙ (1 ft)), velocity thresholds (e.g., aggregated velocity value>Vₘₐₓ (e.g., 5.6 ft/sec) or <Vₘᵢₙ (0.2 ft/sec)), acceleration thresholds (e.g., aggregated acceleration value>Aₘₐₓ (e.g., 2 ft/sec²) or <Aₘᵢₙ (0.1 ft/sec²)), confidence thresholds (e.g., aggregated confidence value<Cₘᵢₙ (80%)), gain thresholds (e.g., aggregated gain value>Gₘₐₓ or <Gₘᵢₙ), and/or the like.

In some embodiments, the contextual thresholds are configuration parameters 416 that define a filtering constraint for an excursion feature parameter associated with a defined contextual attribute. A contextual threshold may include one or more threshold (e.g., a minimum and/or a maximum) distance and/or duration measurements for the distance feature value and/or duration feature value, respectively. By way of example, the contextual thresholds may include one or more total distance thresholds (e.g., distance feature value>Dₘₐₓ (e.g., 100 ft) or <Dₘᵢₙ (e.g., 1 ft)), total linear distance (e.g., Origin>CFDₘₐₓ or <CFDₘᵢₙ), total time thresholds (e.g., duration feature value>Tₘₐₓ (e.g., 500 sec) or Tₘᵢₙ (e.g., 10 sec)), minimum percentage of human classified data points, minimum linear distance from origin (e.g., 100 cm), maximum time without moving the minimum linear distance (e.g., 12 seconds), and/or the like.

In some embodiments, in response to detecting the triggering event, an excursion message 420 may be provided by the ambient sensing device 404. The excursion message 420, for example, may include a device identifier and the plurality of sensor-based feature values 414. The sensor-based feature values 414 may respectively correspond to the plurality of excursion feature parameters associated with (a) the entity signature definition and (b) the one or more defined contextual attributes. In some examples, the excursion message 420 may include IP address of the ambient sensing device 404.

In some embodiments, the excursion message 420 is a data entity that describes a message between an ambient sensing device 404 and a prediction system. The excursion message 420, for example, may include a plurality of sensor-based feature values 414 corresponding to an excursion event 418. For example, the ambient sensing device 404 may transmit a plurality of, non-discarded, sensor-based feature values 414 respectively corresponding to the plurality of excursion feature parameters through an excursion message 420. In some examples, the excursion message may include one or more device identifiers, a device location, the plurality of sensor-based feature values, and/or the like.

In some examples, the excursion message 420 may include one or more device identifiers 424. The device identifiers 424 may include a unique identifier of the ambient sensing device 404. The device identifiers 424, for example, may include an assigned unique identifier and/or an Internet Protocol (IP) address of the ambient sensing device 404. In addition, or alternatively, the excursion message may include location data associated with the ambient sensing device, such as one or more relative coordinates, a relative location tag (e.g., bedroom, kitchen, living room, hallway), and/or the like. In some examples, a device identifier may correspond to a relative location data, such that a device identifier may identify a device located within a particular relative (or global) location.

In some examples, the ambient sensing device 404 may issue one or more heartbeat messages in addition to the excursion message 420. The heartbeat messages, for example, may include the one or more device identifiers 424 and may be transmitted at a heartbeat frequency (e.g., one hour, ninety minutes etc.) to confirm a status (and network address) of the ambient sensing device 404 to the prediction system. In some examples, the heartbeat messages may enable the prediction system to push information (e.g., configuration parameters 416, etc.) to the ambient sensing device 404 (e.g., over-the-air updates). By way of example, a prediction system may push heartbeat response messages that may identify one or more configuration parameters 416 for download by the ambient sensing device 404.

In some embodiments, a heartbeat message comprises a replicated structure of an excursion message 420. A heartbeat message, for example, may include a same size and/or length of an excursion message 420. In some examples, the heartbeat message may include one or more device identifiers 422, device locations, a plurality of sensor-based feature values, and/or the like. Up to each of the message attributes may be duplicated from a prior excursion message and/or randomly generated to create a message that mirror the structure of an excursion message 420. In some examples, an excursion message 420 and/or a heartbeat message may comprise a message header with one or more message flags. In some examples, a message flag (e.g., a binary single bit flag) may include a heartbeat flag that is set to differentiate the excursion message 420 (e.g., with a “0”) from a heartbeat message (e.g., with a “1”). In this manner, a heartbeat message may simulate movement within a monitored environment 402 to adverse parties without access to a location (or knowledge) of the heartbeat flag.

In some examples, a heartbeat message may be emitted from the ambient sensing device 404 at a dynamic interval to further obscure the heartbeat message from an excursion message 420. For example, a heartbeat message may be emitted at a random interval within a heartbeat frequency (e.g., random intervals sent at least every ninety minutes). In this manner, heartbeat messages may signal random movements within a monitored environment 402 that may obscure the presence of the target objects within a monitored environment 402 to adverse parties. In this manner, the ambient sensing devices 404 may be implemented within a monitored environment 402 without exposing the monitored environment 402 to adverse parties (e.g., hackers intending to burglarize and empty house).

In this way, a local filter mechanism 422 may be leveraged by an ambient sensing device 404 to filter excursion messages 420 between the ambient sensing device 404 and network connected computing systems. In some examples, the ambient sensing device 404 may leverage the local filter mechanism 422 to continuously provide filtered excursion messages 420 to the network connected computing systems, such a prediction system. The prediction system may receive the prefiltered excursion messages 420 and, using some of the techniques of the present disclosure, identify a tracking target represented by the excursion messages 420 and securely track features of the tracking target. In some examples, a tracking target may be identified by automatically calibrating the ambient sensing device 404 using a plurality of filtered excursion messages 420 received over a calibration time period. An operational example of one such calibration technique is described further with reference to FIG. 5.

FIG. 5 is an example data flow diagram 500 of an automated calibration technique in accordance with some embodiments discussed herein. The automated calibration technique, for example, may be automatically performed, during a calibration time period for an ambient sensing device, to generate identifying information for one or more tracking targets within a monitored environment without a priori knowledge of the one or more targets. The identifying information may include one or more tracking target signatures 518 that may be used to identify a tracking target within a monitored environment 402 without exposing personally identifiable information (PII) of the tracking target. In this manner, the automated calibration technique enables tracking operations that track features of a tracking target without subjecting the tracking target to network privacy attacks. This allows for privacy tolerant ambient sensing devices that may be automatically configured without user input.

In some embodiments, an excursion message 420 reflective of an excursion event is received by a prediction system 502. The excursion message 420, for example, may originate from the ambient sensing device during a calibration time period for the ambient sensing device. The ambient sensing device, for example, may include a radar sensor configured to generate movement data. The ambient sensing device may be configured to provide the excursion message 420 responsive to the movement data and one or more excursion event criteria, as described herein.

In some embodiments, the prediction system 502 is a computing entity that includes one or more processors and memory that are collectively configured to perform one or more operations of the present disclosure. A prediction system 502, for example, may include a centralized, cloud-based, and/or the like server that is communicatively connected to a plurality of ambient sensing devices. The prediction system 502 may receive a plurality excursion messages 420 from each of the plurality of ambient sensing devices and perform one or more calibration and/or predictive operations for one or more tracking targets within a plurality of monitored environments 402 of the plurality of ambient sensing devices.

In some examples, the one or more operations performed by the prediction system 502, responsive to one or more excursion messages 420 of a respective ambient sensing device, may be based on a time period of the ambient sensing device's lifetime. For example, during one or more calibration time periods, the prediction system 502 may perform one or more calibration operations in response to a plurality of excursion messages 420 from an ambient sensing device. During one or more prediction time periods, the prediction system 502 may perform one or more prediction operations in response to a plurality of excursion messages 420 from the ambient sensing device.

In some embodiments, the calibration time period is a temporal parameter that defines a duration of a calibration activity for an ambient sensing device. A calibration time period, for example, may include a configurable parameter that defines a setup time for an ambient sensing device after the device is installed within a monitored environment. In some examples, the calibration time period may include one or more days, weeks, and/or the like. During the calibration time period, the prediction system 502 may receive a plurality of excursion messages 420 from an ambient sensing device and, using the plurality of sensor-based feature values 414 thereof, automatically establish one or more tracking target signatures 518 for one or more tracking targets within a monitored environment 402. To do so, the prediction system 502 may identify a candidate entity signature 508 and/or one or more contextual attributes 510 from the plurality of sensor-based features values of each of the excursion messages.

The excursion message 420 may include a plurality of sensor-based feature values 414 respectively corresponding to a plurality of excursion feature parameters associated with (a) an entity signature definition and (b) one or more defined contextual attributes. The movement data, for example, may include three-dimensional point cloud data and the plurality of sensor-based feature values 414 may be generated from the three-dimensional point cloud data based on the plurality of excursion feature parameters. The multi-dimensional point cloud data may include one or more three-dimensional point clouds and the plurality of excursion feature parameters may identify a point cloud height, a point cloud width and/or girth, a point cloud's centroid location, a point cloud velocity, a point cloud acceleration, a point cloud confidence level, a point cloud gating function gain, a point cloud tracking error variance, a point cloud group variance, and/or the like, as described herein. In some examples, the first subset of the plurality of sensor-based feature values 414 correspond to an aggregated height parameter, aggregated width and/or girth parameter(s), an aggregated velocity parameter, an aggregated acceleration parameter, an aggregated confidence parameter, an aggregated gain parameter, an aggregated error tracking variance parameter, and/or an aggregated group variance parameter. In some examples, the second subset of the plurality of sensor-based feature values 414 correspond to an aggregated velocity parameter, a distance feature parameter, and/or a duration feature parameter.

In some embodiments, a candidate entity signature 508 is identified for the excursion event based on a first subset of the plurality of sensor-based feature values 414 that correspond to the entity signature definition. In addition, or alternatively, one or more contextual attributes 510 may be identified based on a second subset of the plurality of sensor-based feature values 414 that correspond to the one or more defined contextual attributes.

In some embodiments, the candidate entity signature 508 is a set of sensor-based feature values 414 from an excursion message 420 that correspond to an entity signature definition. A candidate entity signature 508, for example, may include a subset of the plurality of sensor-based feature values 414 that corresponds to the parameters of an entity signature definition. In some examples, the prediction system 502 may generate one or more tracking target signatures 518 for one or more tracking targets within a monitored environment 402. The tracking target signatures 518 may be generated by extracting a candidate entity signature 508 from each of a plurality of excursion messages 420 received over a calibration time period. Once a tracking target signature 518 is established, the candidate entity signature 508 may be extracted from an excursion message 420 and compared to the tracking target signature 518 to identify a tracking target without exposing PII for the tracking target. As described herein, a tracking target signature 518 may include a centroid mean and a standard deviation. The candidate entity signature 508 may be compared to a tracking target signature 518 by determining a number of standard deviations between the subset of the plurality of sensor-based feature values 414 of the excursion message 420 and the centroid mean (e.g., establishing a subset of a plurality of sensor-based feature values 414 for a tracking target) in a multidimensional parameter space. In some examples, a match probability (e.g., 90% within 2 standard deviations, 75% within 3 standard deviations, 50% within 4 standard deviations, etc.) may be generated based on the number of standard deviations. In some examples, a match between the candidate entity signature 508 and a tracking target signature 518 may be generated if the match probability achieves a configurable threshold (e.g., 75%, etc.).

In some embodiments, the contextual attributes 510 are sensor-based feature values from an excursion message 420 that corresponds to a defined contextual attribute. A contextual attribute, for example, may identify an activity level associated with an excursion event. By way of example, a contextual attribute may be reflective of a velocity, total distance, and/or time of an excursion event. In some examples, the contextual attributes 510 may be leveraged to generate a tracking target signature 518 and/or one or more predictive features for a tracking target signature.

In some embodiments, a plurality of candidate entity clusters 514 is generated based on a comparison between the candidate entity signature 508 and a plurality of candidate entity signatures respectively corresponding to a plurality of excursion messages 420 received within a calibration time period. The plurality of candidate entity clusters 514, for example, may be generated using a point clustering model. The point clustering model, for example, may include a multi-dimensional k-means clustering algorithm. Each candidate entity cluster of the plurality of candidate entity clusters 514 may identify a subset of the plurality of excursion messages 420.

In some embodiments, the candidate entity clusters 514 are multi-dimensional datapoints that describes one or more candidate entity signatures from a plurality of excursion messages 420 received during a calibration time period. For example, during a calibration time period, a prediction system may receive an excursion message 420, extract a candidate entity signature 508 from the excursion message 420, and map the candidate entity signature 508 to a multi-dimensional space. By way of example, each candidate entity signature 508 may be mapped to a multi-dimensional space based on at least two of the aggregated height value, aggregated width and/or girth value(s), aggregated velocity value, aggregated total distance value, aggregated acceleration value, aggregated gain value, aggregated tracking error variance value, aggregated group variance value, and/or the like. The candidate entity signature 508 may be mapped to the multi-dimensional space with a plurality of candidate entity signatures received during the calibration time period. Once mapped, a point clustering model may be leveraged to generate a plurality of candidate entity clusters 514 based on the mapped values of each of the plurality of candidate entity signatures 508. For each cluster, a centroid mean and standard deviation may be generated by aggregating the mapped values of each of a subset of candidate entity signatures within the candidate entity clusters 514.

In some embodiments, the point clustering model is a data entity that describes parameters, hyper-parameters, and/or defined operations of a rules-based and/or machine learning model (e.g., model including at least one of one or more rule-based layers, one or more layers that depend on trained parameters, coefficients, and/or the like). The point clustering model may include any type of model configured, trained, and/or the like to generate one or more candidate entity clusters 514 from a plurality of multi-dimensional datapoints received during a calibration time period. In some examples, the point clustering model may include a multi-dimensional k-means clustering model. In some examples, k may be a configurable parameter that may be set based on an anticipated number of tracking targets within a monitored environment 402.

In some embodiments, one or more tracking targets are identified based on the plurality of candidate entity clusters 514 and the one or more contextual attributes 510. For example, a plurality of candidate target parameter values 516 may be generated for the plurality of candidate entity clusters 514. Each candidate target parameter value of the plurality of candidate target parameter values 516 may be generated for a candidate entity cluster by aggregating one or more candidate contextual attributes from the subset of the plurality of excursion messages 420. In some examples, a contextual attribute of the one or more contextual attributes 510 may be a velocity feature and the candidate target parameter value 516 identifies a median velocity of a plurality of velocity features respectively associated with the subset of the plurality of excursion messages 420.

In some embodiments, the candidate target parameter values 516 are data values that describe a cluster-level sensor-based feature values for a tracking target selection parameter. For example, the tracking target selection parameter may be defined based on selection criteria for tracking target signatures 518 from a plurality of candidate entity clusters 514. In some examples, the candidate target parameter values 516 may include aggregated velocity values for the candidate entity clusters 514. By way of example, a prediction system 502 may generate a mean and standard deviation for a velocity feature value across each of a subset of excursion messages 420 associated with a candidate entity cluster. In some examples, a tracking target signature 518 may be selected as the slowest (e.g., lowest velocity feature value, etc.) candidate entity cluster. In some examples, multiple tracking target signatures 518 may be selected for a monitored environment 402 to ensure that the activity of a single designated tracking target is captured within the monitored environment 402. For example, a primary tracking target signature may be selected for a primary tracking target based on the slowest (e.g., lowest velocity feature value, etc.) candidate entity cluster. In addition, or alternatively, a secondary tracking target signature may be selected for a secondary tracking target based on a next slowest (e.g., second lowest velocity feature value, etc.) candidate entity cluster.

In some examples, the one or more tracking targets may include a primary and secondary tracking target. The primary tracking target may be identified based on a first minimum candidate target parameter value of the plurality of candidate target parameter values 516. The secondary tracking target may be identified based on a second minimum candidate target parameter value of the plurality of candidate target parameter values 516. In some embodiments, the primary tracking target is a tracking target that is associated with a lowest candidate target parameter value. In some embodiments, the secondary tracking target is a tracking target that is associated with a second lowest candidate target parameter value.

In some embodiments, one or more tracking target signatures 518 respectively corresponding to the one or more tracking targets are stored for a target log file 520 corresponding to the ambient sensing device. For example, a candidate entity cluster 514 may be identified that corresponds to a tracking target signature of the one or more tracking target signatures 518. A centroid mean and/or a centroid standard deviation may be generated for the candidate entity cluster 514 and stored in the target log file 520 corresponding to the ambient sensing device.

In some embodiments, the tracking target signatures 518 are entity signatures of a tracking target. The tracking target signatures 518, for example, may include baseline activity signatures that are automatically generated during a calibration time period for a tracking target. By way of example, during the calibration time period, the prediction system 502 may establish a baseline activity signatures for a tracking target (e.g., a household occupant, etc.) for an ambient sensing device. Subsequent to the calibration time period, an entity signature may be compared to the tracking target signatures 518 to match an excursion message 420 to a tracking target without using personally identifiable information for the tracking target.

In some examples, the tracking target signatures 518 may include one or more centroid and/or standard deviation values for a tracking target. The centroid and/or standard deviation values, for example, may correspond to a candidate entity cluster associated with the tracking target signature. For example, the centroid and/or standard deviation values may be generated by aggregating the feature values of each of a subset of candidate entity signatures within the candidate entity cluster associated with the tracking target signature.

In some embodiments, the target log file 520 is a data structure that stores a plurality of historical contextual attributes for a tracking target. A target log file 520, for example, may correspond to a tracking target signature 518 and may store a plurality of historical contextual attributes received from excursion messages 420 that include a matching entity signature. In this manner, a target log file 520 may be maintained for a tracking target without exposing PII of the tracking target.

In some embodiments, the plurality of excursion messages 420 is temporarily stored during the calibration time period for the ambient sensing device. A termination of the calibration time period may be identified and, responsive to the termination of the calibration time period, the one or more tracking target signatures 518 may be identified and the plurality of excursion messages 420 may be discarded.

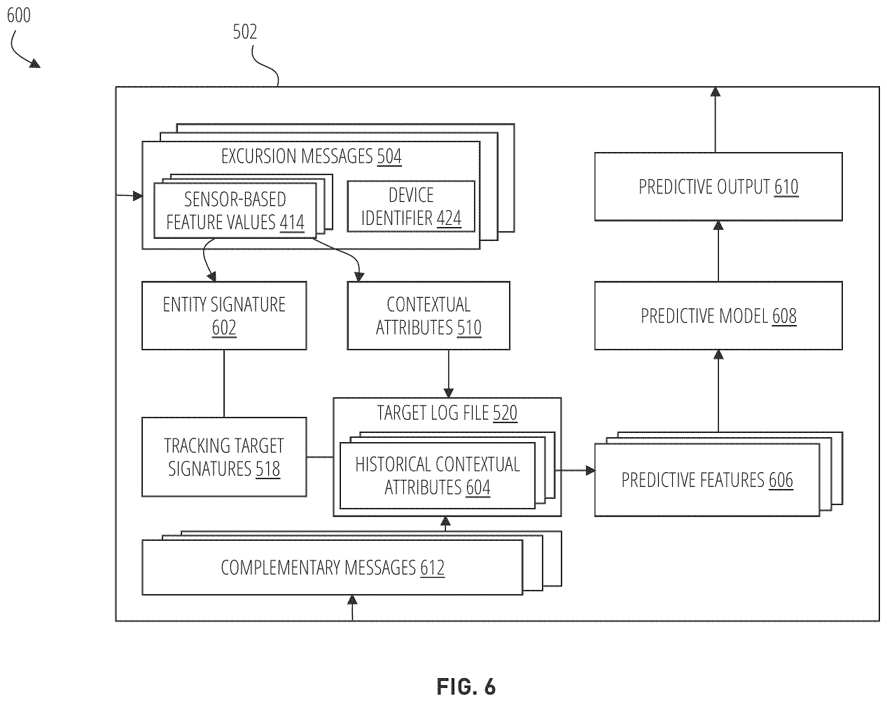

In this way, a prediction system 502 may automatically detect and track relevant activity signatures within a monitored environment 402. After the calibration time period, the prediction system 502 may leverage the tracking target signatures 518 to track activity within a monitored environment and store the activity within a target log file 520. By associating the target log file 520 with a set of innocuous feature values defined by the tracking target signatures 518, the prediction system 502 may track the activity of a tracking target without exposing the target to security risks posed by network communications. An operational example of privacy-enhanced tracking technique powered by these tracking target signatures 518 is described further with reference to FIG. 6.

FIG. 6 is an example data flow diagram 600 of a privacy-enhanced identification and tracking technique in accordance with some embodiments discussed herein. The privacy-enhanced identification and tracking technique, for example, may be performed, after a calibration time period for an ambient sensing device, to track activity information for one or more tracking targets within a monitored environment without the use of PII or other sensitive features, such as facial characteristics. Instead, the privacy-enhanced identification and tracking technique leverages point cloud characteristics extracted from a radar data. These, tracking target signatures 518, may be stored and compared to incoming candidate entity signatures 508 to identify a tracking target without using information that is subset to misuse. The tracking target signatures 518, for example, may be dereferenced from the entity of a tracking target, thereby creating risk-hardened data entity that lacks the independently meaningful information traditionally misused by malicious actors. This enables privacy tolerant ambient sensing techniques that may be used to monitor an environment without exposing entities within the environment to harm.

In some embodiments, an excursion message 420 is received by the prediction system 502. The excursion message 420 may originate from an ambient sensing device after a calibration time period (e.g., during a prediction time period). In some examples, the excursion message 420 may include a plurality of sensor-based feature values 414 respectively corresponding to a plurality of excursion feature parameters associated with (a) an entity signature definition and (b) one or more defined contextual attributes. The sensor-based feature values 414, for example, may include a plurality of point cloud measurements generated, by the ambient sensing device, based on radar data.

In some embodiments, an entity signature 602 for the excursion message 420 is identified based on a first subset of the plurality of sensor-based feature values 414 that correspond to the entity signature definition. The first subset of the plurality of sensor-based feature values 414 may correspond to at least two of a point cloud height, a point cloud width and/or girth, a point cloud velocity, a point cloud acceleration, a point cloud confidence level, a point cloud gating function gain, a point cloud tracking error variance, and/or a point cloud group variance.

In some examples, one or more contextual attributes 510 are identified based on a second subset of the plurality of sensor-based feature values 414 that correspond to the one or more defined contextual attributes. The second subset of the plurality of sensor-based feature values 414 may correspond to a point cloud velocity, distance feature value, and/or a duration feature value.

In some embodiments, a target log file 520 that corresponds to the excursion message 420 is identified based on a comparison between the entity signature 602 and a tracking target signature 518 corresponding to the target log file 520. In some examples, the tracking target signature 518 includes (a) a centroid mean that defines a median aggregated feature value for each of the first subset of the plurality of sensor-based feature values and (b) a centroid standard deviation.

In some examples, the excursion message 420 includes a device identifier 424 corresponding to the ambient sensing device. One or more tracking target signatures 518 may be identified based on the device identifier 424 and the target log file 520 may be identified based on a comparison between the entity signature 602 and the one or more tracking target signatures 518.

In some embodiments, the one or more contextual attributes 510 may be stored as one or more of a plurality of historical contextual attributes 604 of the target log file 520.

In some embodiments, the historical contextual attributes 604 are data values that describe recorded contextual attributes for a tracking target. A historical contextual attribute 604, for example, may include a contextual attribute from an excursion message 420 that includes an entity signature 602 that matches a tracking target signature 518 of the tracking target.

In some embodiments, in response to a temporal assessment trigger event, a plurality of predictive features 606 is generated for a tracking target based on the plurality of historical contextual attributes 604 and one or more evaluation time intervals. The one or more evaluation time intervals may include a one-day time interval, a three-day interval, and a seven-day interval.

In some embodiments, the temporal assessment trigger event is a data entity that triggers the performance of one or more predictive operations of the present disclosure. A temporal assessment trigger event, for example, may include temporal trigger that executes at a defined frequency. The defined frequency may be configurable based on the monitored environment. In some examples, the defined frequency may include a daily frequency. For example, the temporal assessment trigger event may execute each morning. Responsive to the temporal assessment trigger event, a plurality of predictive feature may be generated for one or more evaluation time intervals from the time of the temporal assessment trigger event.

In some embodiments, the evaluation time interval is a temporal parameter that defines a duration of predictive activity for a predictive feature. An evaluation time interval, for example, may be one of a plurality of evaluation time intervals that each define a period of activity that may be predictive of a prediction output. For instance, the plurality of evaluation time intervals may include a one-day time interval, a three-day time interval, a seven-day time interval, and/or the like.

In some examples, a historical attribute subset of the plurality of historical contextual attributes 604 may be identified based on an evaluation time interval of the one or more evaluation time intervals. A predictive feature of the plurality of predictive features 606 may be generated by aggregating a plurality of historical feature values of the historical attribute subset that correspond to an excursion feature parameter of the plurality of excursion feature parameters. In some examples, a plurality of contrasting subsets of the plurality of historical contextual attributes may be identified based on the one or more evaluation time intervals. Each predictive feature of the plurality of predictive features 606 may be generated by generating a first aggregated feature value by aggregating a first plurality of historical feature values of a first contrasting subset that corresponds to an excursion feature parameter of the plurality of excursion feature parameters, generating a second aggregated feature value by aggregating a second plurality of historical feature values of a second contrasting subset that corresponds to the excursion feature parameter of the plurality of excursion feature parameters, and generating the predictive feature based on a comparison between the first aggregated feature value and the second aggregated feature value.

In some embodiments, a predictive feature is a data value that describes an engineered feature for a predictive model 608. A predictive feature, for example, may include one of a plurality of predictive features 606 extracted from a plurality of historical contextual attributes 604 of a target log file 520 for a tracking target. Each predictive feature may reflect a statistical measure of activity for the tracking target over a period of time. By way of example, some of the predictive features 606 may include (i) a total aggregate (e.g., a mean, standard deviation, median, etc.) velocity feature value across all of the historical contextual attributes 604, (ii) a 24-hour total distance of the historical contextual attributes 604, (iii) a prior day's aggregated (e.g., mean, standard deviation, median, etc.) velocity feature value minus the total aggregate velocity feature value, (iv) a prior day's aggregated (e.g., mean, standard deviation, median, etc.) total distance minus the 24-hour total distance, (v) a three-day aggregate (e.g., a mean, standard deviation, median, etc.) velocity feature value minus the total aggregate velocity feature value, (vi) a three-day aggregate (e.g., a mean, standard deviation, median, etc.) total distance minus the 24-hour total distance, (vii) a seven-day aggregate (e.g., a mean, standard deviation, median, etc.) velocity feature value minus the total aggregate velocity feature value, (viii) a seven-day aggregate (e.g., a mean, standard deviation, median, etc.) total distance minus the 24-hour total distance, (ix) a seven-day aggregate (e.g., a mean, standard deviation, median, etc.) velocity feature value minus a two-day aggregate velocity feature value, (x) a seven-day aggregate (e.g., a mean, standard deviation, median, etc.) total distance minus a two-day total distance, (xi) a seven-day aggregate (e.g., a mean, standard deviation, median, etc.) velocity feature value minus the three-day aggregate velocity feature value, (xii) a seven-day aggregate (e.g., a mean, standard deviation, median, etc.) total distance minus the three-day total distance, (xiii) the aggregate velocity feature value of the tracking target signature minus the three-day aggregate velocity feature value, (xiv) the total distance feature value of the tracking target signature minus the three-day total distance, and/or the like.

In some examples, the predictive features 606 may include activity features, as outlined above. In some examples, up to each of the activity features may be normalized by dividing distance by a baseline standard deviation. In addition, or alternatively, the predictive features 606 may include a plurality of complementary features, such as sleep features, auditory features, tactile features, and/or the like. For example, in addition to a plurality of excursion messages 420, the prediction system 502 may receive a plurality of complementary messages 612 for a tracking target.

In some embodiments, complementary messages 612 are received that include a plurality of complementary sensor-based feature values respectively corresponding to a plurality of complementary feature parameters. The complementary messages 612, for example, may originated from a complementary ambient sensing device. The complementary ambient sensing device, for example, may include an ambient sleep sensor and the plurality of complementary sensor-based feature values may identify a sleep score, a heart rate, and/or a respiratory rate. In some examples, the plurality of predictive features 606 may be generated based on the plurality of complementary sensor-based feature values.

In some embodiments, the complementary messages 612 are data entities that describe messages between a complementary ambient sensing device and the prediction system 502. A complementary ambient sensing device, for example, may include a sensing device within and/or otherwise associated with a monitored environment 402 that is configured to generate sensor data that complements the sensor data of the ambient sensing device. For instance, the complementary ambient sensing device may include an audio device (e.g., microphones, etc.), tactile device (e.g., pressure sensors, etc.), and/or the like. In some examples, the complementary ambient sensing device may include a sleep sensing device, such as a sleep mat sensor (e.g., Withing Sleep Mat, etc.), that may transmit a plurality of complementary messages 612 reflective of a plurality of complementary sensor-based feature values for a tracking target.

In some embodiments, a complementary sensor-based feature value is a data value that is measured by a complementary ambient sensing device and reflects a characteristic of a complementary event that complements an excursion event. A complementary sensor-based feature value, for example, may include a sleep score (e.g., 1-100, etc.), an average resting heart rate, an average resting respiratory rate, and/or the like.

In some embodiments, a complementary feature parameter is a data parameter that describes a feature value of interest for complementing an excursion event. A complementary feature parameter, for example, may include a predefined parameter that describes a measurement from a complementary sensing device. The complementary feature parameters, for example, may include a sleep score parameter, a resting heart rate parameter, a resting respiratory rate parameter, and/or the like.

In some examples, a plurality of complementary feature parameters may be leveraged to generate a plurality of complementary features for the predictive model 608. By way of example, after baseline parameters are established (e.g., during a calibration time period), the number of standard deviations (e.g., the distance from the mean for the parameter, divided by the baseline standard deviation for that parameter) for a tracking target may be generated for a tracking target's (i) a sleep score, (ii) an average resting heart rate, (iii) an average resting respiratory rate, (iv) a prior day's sleep score minus the sleep score, (v) a prior day's average resting heart rate minus the average resting heart rate, (vi) a prior day's average resting respiratory rate minus the average resting respiratory rate, (vii) a mean of a past three day's sleep score minus the sleep score, (viii) a mean of the past three day's average resting heart rate minus the average resting heart rate, (ix) a mean of past three day's average resting respiratory rate minus the average resting respiratory rate, (x) a mean of past seven day's sleep score minus sleep score, (xi) a mean of past seven day's average resting heart rate minus the average resting heart rate, (xii) a mean of past seven day's average resting respiratory rate minus the average resting respiratory rate, (xiii) a mean of past seven day's sleep score minus the mean of a past two day's sleep score, (ix) a mean of past seven day's average resting heart rate minus the mean of a past two day's average resting heart rate, (x) a mean of past seven day's average resting respiratory rate minus the mean of the past two day's average resting respiratory rate, (xi) a mean of past seven day's sleep score minus the mean of past three day's sleep score, (xii) a mean of past seven day's average resting heart rate minus the mean of past three day's average resting heart rate, (xiii) a mean of past seven day's average resting respiratory rate minus mean of past three day's average resting respiratory rate, (xiv) a baseline sleep score minus the mean of past three day's sleep score, (xv) a baseline average resting heart rate minus mean of past three day's average resting heart rate, (xvi) a baseline average resting respiratory rate minus the mean of past three day's average resting respiratory rate, and/or the like.

In some embodiments, a predictive output 610 is generated for the tracking target based on the plurality of predictive features 606. The predictive output 610, for example, may be generated using a predictive model 608.

In some embodiments, the predictive model 608 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The predictive model 608 may include any type of model configured, trained, and/or the like to generate a predictive output 610 based on a plurality of predictive features 606. A predictive model 608 may include one or more of any type of machine learning model including one or more supervised, unsupervised, semi-supervised, reinforcement learning models, and/or the like. In some examples, the predictive model 608 may include a plurality of statistical and/or machine learning models.

By way of example, a predictive model 608 may include a regression model that is configured to receive a plurality of predictive features 606 and perform a regression analysis to identify correlations between the predictive features 606 and one or more target outputs (e.g., 1-3 day emergency room visits, 1-2 week emergency room visits, etc. in a clinical example). By way of example, the regression model may include a linear regression model, a polynomial regression model, a multiple regression model, a ridge regression model, and/or the like. In some examples, the regression model may be configured (e.g., trained, etc.) with a plurality of historical positive and negative training pairs that match a plurality of historical predictive features to a positive target output and/or a negative target output, respectively. In some examples, a tracking target may be monitored for a positive and/or negative outcome and the plurality of predictive features may be added to the plurality of historical positive and negative training pairs with a positive target output label and/or a negative target output label reflective of the positive and/or negative outcome. In this manner, the predictive model 608 may learn over time based on real world data.

In some embodiments, a prediction-based action is initiated based on the predictive output 610. In some embodiments, the predictive output 610 is a data value that describes an output of the predictive model 608. The predictive output 610, for example, may include a weighted regression score that identified a probability of a positive and/or negative outcomes for a tracking target. In some examples, the predictive output 610 may be compared to an action threshold and, in response to the predictive output 610 satisfying the action threshold, a prediction-based action may be initiated. The prediction-based action, for example, may include one or more alerts to a tracking target, an agent (e.g., robotic agent, human agent, etc.) for the tracking target, and/or the like. In some examples, the alert may be an auditory and/or visual alert emitted by the ambient sensing device. For example, the prediction system 502 may provide one or more instructions to the ambient sensing device to initiate the prediction-based action.

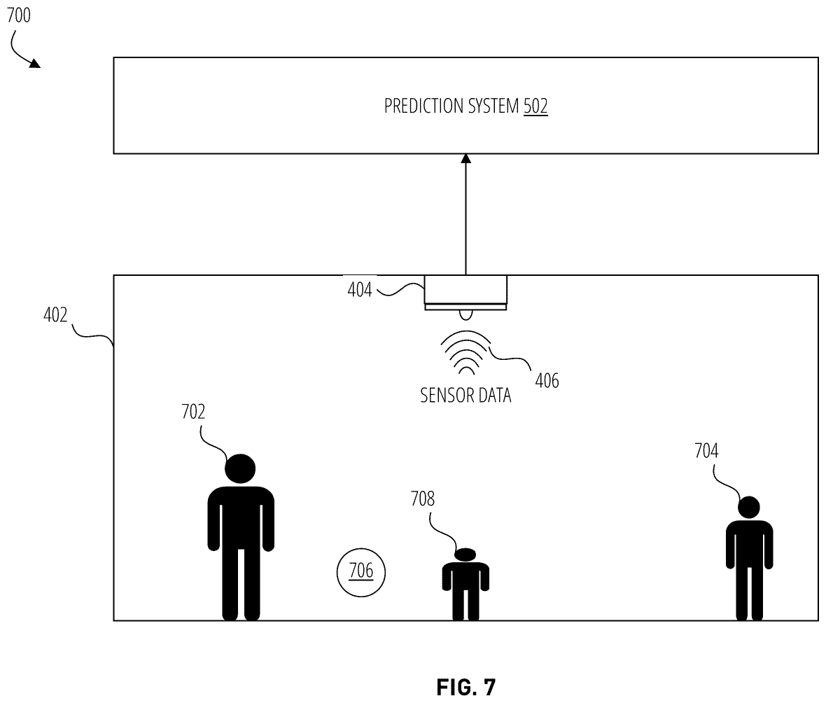

In this way, an ambient sensing device and a prediction system 502 may collaborate to monitor and act on activity within a monitored environment without interacting with tracking targets within the monitored environment. For example, the connected systems may together identify activity within a monitored environment, reduce activity signals to targets of interest, and log signals for the targets of interest without requiring interactions between the targets and the connected systems. In this way, the connected systems may implement an ambient, privacy-enhanced, tracking system that addresses several technical deficiencies of traditional tracking system. An operational example of a monitored environment that employs the connected system is described further with reference to FIG. 7.

FIG. 7 is an operational example 700 of a monitored environment 402 in accordance with some embodiments discussed herein. The operational example 700 includes a monitored environment 402 with a plurality of active entities. The monitored environment 402 may include an ambient sensing device 404 (e.g., attached to the ceiling, attached to the wall, etc.) that is configured to receive sensor data 406 reflective of candidate movements for each of the active entities. However, only a portion of the active entities may be tracking targets. The active entities, for example, may include a primary tracking target 702 (e.g., a first person, etc.), a secondary tracking target 704 (e.g., a second person similar to the first person, etc.), a first non-tracking target 706 (e.g., an inanimate object such as a ball, a non-human animal such as a pet, etc.), and/or a second non-tracking target 708 (e.g., a third person dissimilar to the first person, etc.). Using some of the techniques of the present disclosure, the ambient sensing device 404 and/or the prediction system 502 may discard movement data related to the first non-tracking target 706 and the second non-tracking target 708, while recording predictive features for both the primary tracking target 702 and the secondary tracking target 704. Using these predictive features, the prediction system 502 may initiate prediction-based actions to improve the safety of the monitored environment 402 without interfering with the activities or the privacy of the various active entities within the monitored environment 402.

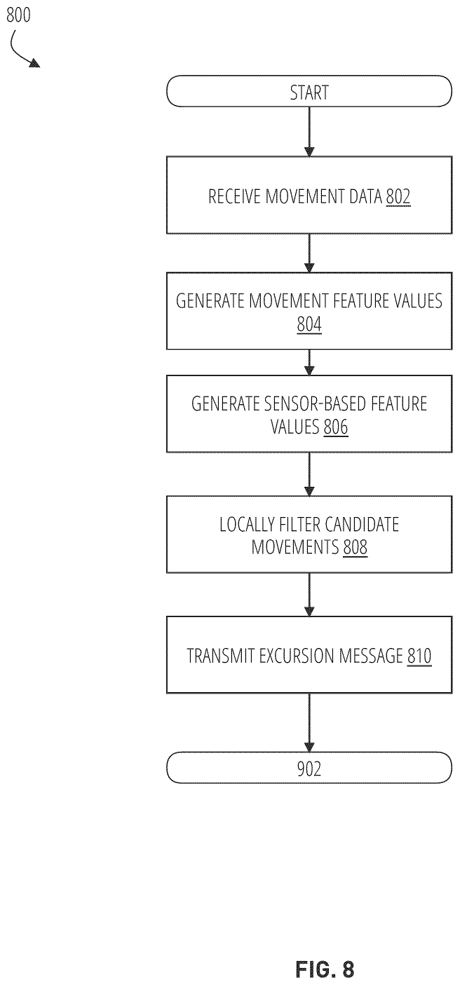

FIG. 8 is a flowchart diagram of a local sensor filtering process 800 in accordance with some embodiments discussed herein. The flowchart depicts a local sensor filtering process 800 for selectively transmitting messages between network connected devices. The process 800 may be implemented by one or more computing devices, entities, and/or systems described herein. For example, via the various steps/operations of the process 800, the computing system 101 may leverage a local filter mechanism to interpret, identify, and filter predictive sensor-based feature values from sensor data continuously received within a monitored environment. By doing so, the process 800 reduces network congestion constraints traditionally encountered when facilitating a continuously monitored environment using a plurality of networked devices.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes, at step/operation 802, receiving movement data. For example, the computing system 101 may receive, using a radar sensor, sensor data by emitting a plurality of radar signals within a monitored environment associated with one or more tracking targets. The plurality of radar signals may be emitted at a reporting time interval. The computing system 101 may generate, using the radar sensor, movement data based on the sensor data. The movement data may be reflective of a candidate movement for the one or more tracking targets within the monitored environment. In some examples, the radar sensor may be configured with an ambient sensing device.

In some embodiments, the process 800 includes, at step/operation 804, generating movement feature values. For example, the computing system 101 may generate a plurality of movement feature values based on the movement data and a plurality of excursion feature parameters associated with (a) an entity signature definition and (b) one or more defined contextual attributes. For instance, the plurality of movement feature values may include a first movement subset that corresponds to the entity signature definition and a second movement subset that corresponds to the one or more defined contextual attributes. In some examples, the second movement subset includes a location value and a time value, and the one or more defined contextual attributes define a distance feature parameter and a duration feature parameter.

In some embodiments, the process 800 includes, at step/operation 806, generating sensor-based feature values. For example, the computing system 101 may generate a plurality of sensor-based feature values for an excursion event based on the plurality of movement feature values and a plurality of historical movement feature values.

In some examples, the computing system 101 may generate a plurality of aggregated feature values that respectively correspond to a first parameter subset of the plurality of excursion feature parameters associated with the entity signature definition by aggregating the first movement subset with a first historical movement subset of the plurality of historical movement feature values. For example, the computing system 101 may identify a first movement feature value from the first movement subset that corresponds to the excursion feature parameter. The computing system 101 may identify a plurality of second movement feature values from the first historical movement subset that corresponds to the excursion feature parameter. The computing system 101 may generate the aggregated feature value for the excursion feature parameter by aggregating the first movement feature value and the plurality of second movement feature values.

In some examples, the computing system 101 may generate a distance feature value corresponding to the distance feature parameter based on a comparison between (a) the location value and (b) an origin location value of the plurality of historical movement feature values. In addition, or alternatively, the computing system 101 may generate a duration feature value corresponding to the duration feature parameter based on a comparison between (a) a time value and (b) an origin time value of the plurality of historical movement feature values.

In some embodiments, the process 800 includes, at step/operation 808, locally filtering candidate movements. For example, the computing system 101 may identify a triggering event based on a comparison between the plurality of sensor-based feature values and excursion event criteria.

The excursion event criteria, for example, may include one or more signature-based thresholds that each define a particular threshold range for a particular aggregated feature value of the plurality of aggregated feature values. In some examples, the computing system 101 may receive, from the prediction system, one or more tracking target signatures respectively corresponding to the one or more tracking targets. The computing system 101 may modify the one or more signature-based thresholds based on the one or more tracking target signatures.

In some examples, the excursion event criteria may include one or more contextual thresholds that include (i) a distance threshold defining a minimum travel distance and a maximum travel distance for the excursion event and (ii) a time threshold defining a minimum movement time and a maximum movement time for the excursion event. The computing system 101 may receive, from the prediction system, one or more configuration parameters and modify the one or more contextual thresholds based on the one or more configuration parameters.

In some embodiments, the process 800 includes, at step/operation 810, transmitting excursion messages. For example, the computing system 101 may, in response to detecting the triggering event, provide, to a prediction system, an excursion message that includes (i) a device identifier and (ii) the plurality of sensor-based feature values respectively corresponding to the plurality of excursion feature parameters associated with (a) the entity signature definition and (b) the one or more defined contextual attributes. In some examples, the excursion message may include an Internet Protocol (IP) address of the ambient sensing device.

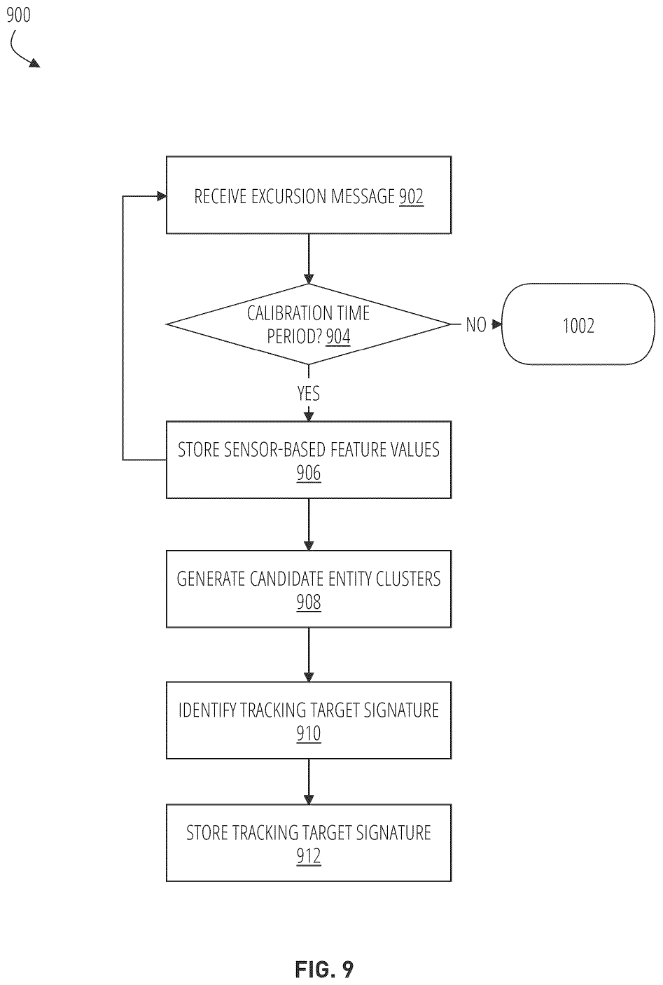

FIG. 9 is a flowchart diagram of an automated calibration process 900 in accordance with some embodiments discussed herein. The flowchart depicts an automated calibration process 900 for calibrating an ambient sensing device without active user interaction. The process 900 may be implemented by one or more computing devices, entities, and/or systems described herein. For example, via the various steps/operations of the process 900, the computing system 101 may leverage filtered sensor-based feature values to generate identifying signatures for entities within a monitored environment without direct participation of the entities and without references PII of the entities. By doing so, the process 900 facilitates an automated calibration technique for tailoring an ambient sensing device to a monitored environment without a priori information of the monitored environment. This, in turn, enables an adaptable ambient sensing device that is automatically adapted to any environment without user input.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 may begin after step/operation 810 of the process 800, where the computing system 101 transmits an excursion message. The process 900, for example, may be performed, in response to an excursion message from an ambient sensing device.

In some embodiments, the process 900 includes, at step/operation 902, receiving an excursion message. For example, the computing system 101 may receive, originating from an ambient sensing device, the excursion message reflective of an excursion event. The excursion message may include a plurality of sensor-based feature values respectively corresponding to a plurality of excursion feature parameters associated with (a) an entity signature definition and (b) one or more defined contextual attributes.

The ambient sensing device, for example, may include a radar sensor configured to generate movement data. The ambient sensing device is configured to provide the excursion message responsive to the movement data and one or more excursion event criteria. The movement data includes multi-dimensional point cloud data. In some examples, the plurality of sensor-based feature values may be generated from the multi-dimensional point cloud data based on the plurality of excursion feature parameters.

The multi-dimensional point cloud data may include one or more three-dimensional point clouds and the plurality of excursion feature parameters may identify a point cloud height, a point cloud width and/or girth, a point cloud's centroid location, a point cloud velocity, a point cloud acceleration, a point cloud confidence level, a point cloud gating function gain, a point cloud tracking error variance, and/or a point cloud group variance. The first subset of the plurality of sensor-based feature values may correspond to an aggregated height parameter, an aggregated width and/or girth parameter(s), an aggregated velocity parameter, an aggregated acceleration parameter, an aggregated confidence parameter, an aggregated gain parameter, an aggregated tracking error variance parameter, and/or an aggregated group variance parameter. The second subset of the plurality of sensor-based feature values may correspond to an aggregated velocity parameter, a distance feature parameter, and a duration feature parameter.

In some embodiments, the process 900 includes, at step/operation 904, determining a status of the ambient sensing device. For example, the computing system 101 determine whether the ambient sensing device is operating within a calibration time period. In the event that the ambient sensing device is operating within a calibration time period, the process 900 may proceed to step/operation 906 of process 900. Otherwise, the process 900 may proceed to step/operation 1002 of process 1000.

In some embodiments, the process 900 includes, at step/operation 906, storing the sensor-based feature values from the excursion message. For example, the computing system 101 identify and store (a) a candidate entity signature for the excursion event based on a first subset of the plurality of sensor-based feature values that correspond to the entity signature definition and (b) one or more contextual attributes based on a second subset of the plurality of sensor-based feature values that correspond to the one or more defined contextual attributes.

In some embodiments, the process 900 includes, at step/operation 908, generating one or more candidate entity clusters. For example, the computing system 101 may generate, using a point clustering model, a plurality of candidate entity clusters based on a comparison between the candidate entity signature and a plurality of candidate entity signatures respectively corresponding to a plurality of excursion messages received within the calibration time period. For instance, a candidate entity cluster of the plurality of candidate entity clusters may identify a subset of the plurality of excursion messages. The point clustering model may include a multi-dimensional k-means clustering algorithm.

In some embodiments, the process 900 includes, at step/operation 910, identifying a tracking target signature. For example, the computing system 101 may identify one or more tracking targets based on the plurality of candidate entity clusters and the one or more contextual attributes. For instance, the computing system 101 may generate a plurality of candidate target parameter values for the plurality of candidate entity clusters. Each candidate target parameter value of the plurality of candidate target parameter values may be generated for a candidate entity cluster by aggregating one or more candidate contextual attributes from the subset of the plurality of excursion messages. In some examples, a contextual attribute of the one or more contextual attributes is a velocity feature and the candidate target parameter value identifies a median velocity of a plurality of velocity features respectively associated with the subset of the plurality of excursion messages. The computing system 101 may identify a primary tracking target based on a first minimum candidate target parameter value of the plurality of candidate target parameter values. In addition, or alternatively, the computing system 101 may identify a secondary tracking target based on a second minimum candidate target parameter value of the plurality of candidate target parameter values.

In some examples, a plurality of excursion messages may be temporarily stored during the calibration time period. The computing system 101 may identify a termination of the calibration time period and, responsive to the termination of the calibration time period, identify the one or more tracking target signatures and discard the plurality of excursion messages.

In some embodiments, the process 900 includes, at step/operation 912, storing the tracking target signature. For example, the computing system 101 may store one or more tracking target signatures respectively corresponding to the one or more tracking targets for a target log file corresponding to the ambient sensing device. For instance, the computing system 101 may identify a candidate entity cluster corresponding to a tracking target signature of the one or more tracking target signatures. The computing system 101 may generate a centroid mean and a centroid standard deviation for the candidate entity cluster. The computing system 101 may store the centroid mean and the centroid standard deviation in the target log file corresponding to the ambient sensing device.

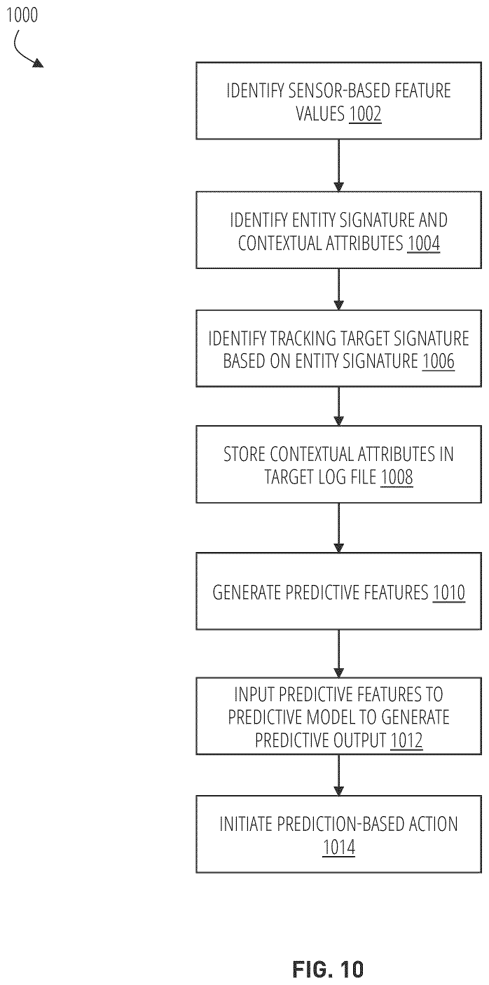

FIG. 10 is a flowchart diagram of a privacy-enhanced identification and tracking process 1000 in accordance with some embodiments discussed herein. The flowchart depicts an identification and tracking process 1000 for tracking the activity of a target entity without knowledge of the entity's identity or any PII. The process 1000 may be implemented by one or more computing devices, entities, and/or systems described herein. For example, via the various steps/operations of the process 1000, the computing system 101 may leverage feature matching techniques to match sensor-based feature values to an entity based on a tracking target signature made up of non-sensitive information that, by itself, cannot be traced to an individual. By doing so, the process 1000 facilitates the privacy-enhanced tracking techniques for monitoring an environment without exposing sensitive information of entities within the environment.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 may begin after step/operation 904 of the process 900, where the computing system 101 determines whether the ambient sensing device is operating in a calibration time period. In the event that the ambient sensing device is not operating in a calibration time period, the process 1000 may be performed for tracking a target entity within a monitored environment.

In some embodiments, the process 1000 includes, at step/operation 1002, identifying sensor-based feature values. For example, the computing system 101 may receive, originating from an ambient sensing device, an excursion message that includes a plurality of sensor-based feature values respectively corresponding to a plurality of excursion feature parameters associated with (a) an entity signature definition and (b) one or more defined contextual attributes. The sensor-based feature values, for example, may include a plurality of point cloud measurements generated, by the ambient sensing device, based on radar data.

In some examples, the first subset of the plurality of sensor-based feature values correspond to at least two of a point cloud height, a point cloud width and/or girth, a point cloud velocity, a point cloud acceleration, a point cloud confidence level, a point cloud gating function gain, a point cloud tracking error variance, and/or a point cloud group variance. In some examples, the second subset of the plurality of sensor-based feature values correspond to a point cloud velocity, distance feature value, and/or a duration feature value.

In some embodiments, the process 1000 includes, at step/operation 1004, identifying an entity signature and contextual attributes. For example, the computing system 101 may identify (a) an entity signature for the excursion message based on a first subset of the plurality of sensor-based feature values that correspond to the entity signature definition, and (b) one or more contextual attributes based on a second subset of the plurality of sensor-based feature values that correspond to the one or more defined contextual attributes.

In some embodiments, the process 1000 includes, at step/operation 1006, identifying a tracking target signature based on the entity signature. For example, the computing system 101 may identify a target log file corresponding to the excursion message based on a comparison between the entity signature and a tracking target signature corresponding to the target log file. In some examples, the tracking target signature includes (a) a centroid mean that defines a median aggregated feature value for each of the first subset of the plurality of sensor-based feature values and (b) a centroid standard deviation.

In some examples, excursion message may include a device identifier corresponding to the ambient sensing device. The computing system 101 may identify one or more tracking target signatures based on the device identifier and identify the target log file based on a comparison between the entity signature and the one or more tracking target signatures.

In some embodiments, the process 1000 includes, at step/operation 1008, storing the contextual attributes in a target log file corresponding to the tracking target signature. For example, the computing system 101 may store the one or more contextual attributes as one or more of a plurality of historical contextual attributes of the target log file.

In some embodiments, the process 1000 includes, at step/operation 1010, generating predictive features. For example, the computing system 101 may, in response to a temporal assessment trigger event, generate a plurality of predictive features for a tracking target based on the plurality of historical contextual attributes and one or more evaluation time intervals. In some examples, the one or more evaluation time intervals may include a one-day time interval, a three-day interval, and a seven-day interval.

In some examples, the computing system 101 may identify a historical attribute subset of the plurality of historical contextual attributes based on an evaluation time interval of the one or more evaluation time intervals and generate a predictive feature of the plurality of predictive features by aggregating a plurality of historical feature values of the historical attribute subset that correspond to an excursion feature parameter of the plurality of excursion feature parameters.

In some examples, the computing system 101 may identify a plurality of contrasting subsets of the plurality of historical contextual attributes based on the one or more evaluation time intervals. The computing system 101 may generate a predictive feature of the plurality of predictive features by generating a first aggregated feature value by aggregating a first plurality of historical feature values of a first contrasting subset that corresponds to an excursion feature parameter of the plurality of excursion feature parameters, generating a second aggregated feature value by aggregating a second plurality of historical feature values of a second contrasting subset that corresponds to the excursion feature parameter of the plurality of excursion feature parameters, and generating the predictive feature based on a comparison between the first aggregated feature value and the second aggregated feature value.

In some examples, the computing system 101 may receive, originating from a complementary ambient sensing device, a complementary message that comprises a plurality of complementary sensor-based feature values respectively corresponding to a plurality of complementary feature parameters. The computing system 101 may generate the plurality of predictive features based on the plurality of complementary sensor-based feature values. In some examples, the complementary ambient sensing device may include an ambient sleep sensor and the plurality of complementary sensor-based feature values identify a sleep score, a resting heart rate, and a resting respiratory rate.

In some embodiments, the process 1000 includes, at step/operation 1012, inputting the predictive features to a predictive model to generate a predictive output. For example, the computing system 101 may, in response to a temporal assessment trigger event, generate, using the predictive model, the predictive output for the tracking target based on the plurality of predictive features.

In some embodiments, the process 1000 includes, at step/operation 1014, initiating prediction-based action. For example, the computing system 101 may initiate a prediction-based action based on the predictive output.

Some techniques of the present disclosure enable the generation of action outputs that may be performed to initiate one or more real world actions to achieve real-world effects. The techniques of the present disclosure may be used, applied, and/or otherwise leveraged to generate a predictive output that may be leveraged to initiate a control of a device (e.g., an ambient sensing device, etc.) via one or more control instructions, and/or the like. Using some of the techniques of the present disclosure, a predictive output may be interpreted to trigger the performance of actions at a user device, the ambient sensing device, a robotic agent, a voice assistant, and/or the like. The actions, for example, may include a visual, auditory, and/or tactile alert that is reflective of a predictive output for a tracking target within a monitored environment. In some embodiments, a predictive output triggers an alert for a user. In addition, or alternatively, the predictive output may trigger (e.g., via one or more control instructions) an action by a robotic device (e.g., by controlling a lighting sequence, etc.).

In some examples, the computing tasks may include actions that may be based on a prediction domain. A prediction domain may include any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors and using a radar sensor, sensor data by emitting a plurality of radar signals within a monitored environment associated with one or more tracking targets; generating, by the one or more processors and using the radar sensor, movement data based on the sensor data and that is reflective of a candidate movement for the one or more tracking targets within the monitored environment; generating, by the one or more processors, a plurality of movement feature values based on the movement data and a plurality of excursion feature parameters associated with (a) an entity signature definition and (b) one or more defined contextual attributes; generating, by the one or more processors, a plurality of sensor-based feature values for an excursion event based on the plurality of movement feature values and a plurality of historical movement feature values; identifying, by the one or more processors, a triggering event based on a comparison between the plurality of sensor-based feature values and excursion event criteria; and in response to detecting the triggering event, providing, by the one or more processors and to a prediction system, an excursion message that comprises (i) a device identifier and (ii) the plurality of sensor-based feature values respectively corresponding to the plurality of excursion feature parameters associated with (a) the entity signature definition and (b) the one or more defined contextual attributes.

Example 2. The computer-implemented method of example 1, wherein the plurality of radar signals is emitted at a reporting time interval.

Example 3. The computer-implemented method of any of the preceding examples, wherein the plurality of movement feature values comprises a first movement subset that corresponds to the entity signature definition and a second movement subset that corresponds to the one or more defined contextual attributes.

Example 4. The computer-implemented method of example 3, wherein generating the plurality of sensor-based feature values comprises generating a plurality of aggregated feature values that respectively correspond to a first parameter subset of the plurality of excursion feature parameters associated with the entity signature definition by aggregating the first movement subset with a first historical movement subset of the plurality of historical movement feature values.

Example 5. The computer-implemented method of example 4, wherein generating an aggregated feature value for an excursion feature parameter of the first parameter subset comprises identifying a first movement feature value from the first movement subset that corresponds to the excursion feature parameter; identifying a plurality of second movement feature values from the first historical movement subset that corresponds to the excursion feature parameter; and generating the aggregated feature value for the excursion feature parameter by aggregating the first movement feature value and the plurality of second movement feature values.

Example 6. The computer-implemented method of examples 4 or 5, wherein the excursion event criteria comprise one or more signature-based thresholds that each define a particular threshold range for a particular aggregated feature value of the plurality of aggregated feature values.

Example 7. The computer-implemented method of example 6, further comprising receiving, from the prediction system, one or more tracking target signatures respectively corresponding to the one or more tracking targets; and modifying the one or more signature-based thresholds based on the one or more tracking target signatures.

Example 8. The computer-implemented method of any of examples 3 through 7, wherein the second movement subset comprises a location value and a time value, the one or more defined contextual attributes define a distance feature parameter and a duration feature parameter, and generating the plurality of sensor-based feature values comprises generating a distance feature value corresponding to the distance feature parameter based on a comparison between (a) the location value and (b) an origin location value of the plurality of historical movement feature values; and generating a duration feature value corresponding to the duration feature parameter based on a comparison between (a) a time value and (b) an origin time value of the plurality of historical movement feature values.

Example 9. The computer-implemented method of example 8, wherein the excursion event criteria comprise one or more contextual thresholds that comprise (i) a distance threshold defining a minimum travel distance and a maximum travel distance for the excursion event and (ii) a time threshold defining a minimum movement time and a maximum movement time for the excursion event.

Example 10. The computer-implemented method of example 9, further comprising receiving, from the prediction system, one or more configuration parameters; and modifying the one or more contextual thresholds based on the one or more configuration parameters.

Example 11. The computer-implemented method of example 1, wherein the radar sensor is configured with an ambient sensing device and the excursion message further comprises a device identifier of the ambient sensing device.

Example 12. A system comprising memory and one or more processors communicatively coupled to the memory, the one or more processors configured to receive, using a radar sensor, sensor data by emitting a plurality of radar signals within a monitored environment associated with one or more tracking targets; generate, using the radar sensor, movement data based on the sensor data and that is reflective of a candidate movement for the one or more tracking targets within the monitored environment; generate a plurality of movement feature values based on the movement data and a plurality of excursion feature parameters associated with (a) an entity signature definition and (b) one or more defined contextual attributes; generate a plurality of sensor-based feature values for an excursion event based on the plurality of movement feature values and a plurality of historical movement feature values; and identify a triggering event based on a comparison between the plurality of sensor-based feature values and excursion event criteria; and in response to detecting the triggering event, provide, to a prediction system, an excursion message that comprises (i) a device identifier and (ii) the plurality of sensor-based feature values respectively corresponding to the plurality of excursion feature parameters associated with (a) the entity signature definition and (b) the one or more defined contextual attributes.

Example 13. The system of example 12, wherein the plurality of radar signals is emitted at a reporting time interval.

Example 14. The system of examples 12 or 13, wherein the plurality of movement feature values comprises a first movement subset that corresponds to the entity signature definition and a second movement subset that corresponds to the one or more defined contextual attributes.

Example 15. The system of example 14, wherein generating the plurality of sensor-based feature values comprises generating a plurality of aggregated feature values that respectively correspond to a first parameter subset of the plurality of excursion feature parameters associated with the entity signature definition by aggregating the first movement subset with a first historical movement subset of the plurality of historical movement feature values.

Example 16. The system of example 15, wherein generating an aggregated feature value for an excursion feature parameter of the first parameter subset comprises identifying a first movement feature value from the first movement subset that corresponds to the excursion feature parameter; identifying a plurality of second movement feature values from the first historical movement subset that corresponds to the excursion feature parameter; and generating the aggregated feature value for the excursion feature parameter by aggregating the first movement feature value and the plurality of second movement feature values.

Example 17. The system of examples 15 or 16, wherein the excursion event criteria comprise one or more signature-based thresholds that each define a particular threshold range for a particular aggregated feature value of the plurality of aggregated feature values.

Example 18. The system of example 17, wherein the one or more processors are further configured to receive, from the prediction system, one or more tracking target signatures respectively corresponding to the one or more tracking targets; and modify the one or more signature-based thresholds based on the one or more tracking target signatures.

Example 19. One or more non-transitory computer-readable storage media including instructions that, when executed by one or more processors, cause the one or more processors to receive, using a radar sensor, sensor data by emitting a plurality of radar signals within a monitored environment associated with one or more tracking targets; generate, using the radar sensor, movement data based on the sensor data and that is reflective of a candidate movement for the one or more tracking targets within the monitored environment; generate a plurality of movement feature values based on the movement data and a plurality of excursion feature parameters associated with (a) an entity signature definition and (b) one or more defined contextual attributes; generate a plurality of sensor-based feature values for an excursion event based on the plurality of movement feature values and a plurality of historical movement feature values; and identify a triggering event based on a comparison between the plurality of sensor-based feature values and excursion event criteria; and in response to detecting the triggering event, provide, to a prediction system, an excursion message that comprises (i) a device identifier and (ii) the plurality of sensor-based feature values respectively corresponding to the plurality of excursion feature parameters associated with (a) the entity signature definition and (b) the one or more defined contextual attributes.

Example 20. The one or more non-transitory computer-readable storage media of example 19, wherein the radar sensor is configured with an ambient sensing device and the excursion message further comprises a device identifier of the ambient sensing device.

What is claimed is:

1. A computer-implemented method comprising:
receiving, by one or more processors and using a radar sensor, sensor data by emitting a plurality of radar signals within a monitored environment associated with one or more tracking targets;
generating, by the one or more processors and using the radar sensor, movement data based on the sensor data and that is reflective of a candidate movement for the one or more tracking targets within the monitored environment;
generating, by the one or more processors, a plurality of movement feature values based on the movement data and a plurality of excursion feature parameters associated with (a) an entity signature definition and (b) one or more defined contextual attributes;
generating, by the one or more processors, a plurality of sensor-based feature values for an excursion event based on the plurality of movement feature values and a plurality of historical movement feature values;
identifying, by the one or more processors, a triggering event based on a comparison between the plurality of sensor-based feature values and excursion event criteria; and
in response to detecting the triggering event, providing, by the one or more processors and to a prediction system, an excursion message that comprises (i) a device identifier and (ii) the plurality of sensor-based feature values respectively corresponding to the plurality of excursion feature parameters associated with (a) the entity signature definition and (b) the one or more defined contextual attributes.

2. The computer-implemented method of claim 1, wherein the plurality of radar signals is emitted at a reporting time interval.

3. The computer-implemented method of claim 1, wherein the plurality of movement feature values comprises a first movement subset that corresponds to the entity signature definition and a second movement subset that corresponds to the one or more defined contextual attributes.

4. The computer-implemented method of claim 3, wherein generating the plurality of sensor-based feature values comprises generating a plurality of aggregated feature values that respectively correspond to a first parameter subset of the plurality of excursion feature parameters associated with the entity signature definition by aggregating the first movement subset with a first historical movement subset of the plurality of historical movement feature values.

5. The computer-implemented method of claim 4, wherein generating an aggregated feature value for an excursion feature parameter of the first parameter subset comprises:
identifying a first movement feature value from the first movement subset that corresponds to the excursion feature parameter;
identifying a plurality of second movement feature values from the first historical movement subset that corresponds to the excursion feature parameter; and
generating the aggregated feature value for the excursion feature parameter by aggregating the first movement feature value and the plurality of second movement feature values.

6. The computer-implemented method of claim 4, wherein the excursion event criteria comprise one or more signature-based thresholds that each define a particular threshold range for a particular aggregated feature value of the plurality of aggregated feature values.

7. The computer-implemented method of claim 6, further comprising:
receiving, from the prediction system, one or more tracking target signatures respectively corresponding to the one or more tracking targets; and
modifying the one or more signature-based thresholds based on the one or more tracking target signatures.

8. The computer-implemented method of claim 3, wherein the second movement subset comprises a location value and a time value, the one or more defined contextual attributes define a distance feature parameter and a duration feature parameter, and generating the plurality of sensor-based feature values comprises:
generating a distance feature value corresponding to the distance feature parameter based on a comparison between (a) the location value and (b) an origin location value of the plurality of historical movement feature values; and
generating a duration feature value corresponding to the duration feature parameter based on a comparison between (a) a time value and (b) an origin time value of the plurality of historical movement feature values.

9. The computer-implemented method of claim 8, wherein the excursion event criteria comprise one or more contextual thresholds that comprise (i) a distance threshold defining a minimum travel distance and a maximum travel distance for the excursion event and (ii) a time threshold defining a minimum movement time and a maximum movement time for the excursion event.

10. The computer-implemented method of claim 9, further comprising:
receiving, from the prediction system, one or more configuration parameters; and
modifying the one or more contextual thresholds based on the one or more configuration parameters.

11. The computer-implemented method of claim 1, wherein the radar sensor is configured with an ambient sensing device and the excursion message further comprises a device identifier of the ambient sensing device.

12. A system comprising memory and one or more processors communicatively coupled to the memory, the one or more processors configured to:
receive, using a radar sensor, sensor data by emitting a plurality of radar signals within a monitored environment associated with one or more tracking targets;
generate, using the radar sensor, movement data based on the sensor data and that is reflective of a candidate movement for the one or more tracking targets within the monitored environment;
generate a plurality of movement feature values based on the movement data and a plurality of excursion feature parameters associated with (a) an entity signature definition and (b) one or more defined contextual attributes;
generate a plurality of sensor-based feature values for an excursion event based on the plurality of movement feature values and a plurality of historical movement feature values; and
identify a triggering event based on a comparison between the plurality of sensor-based feature values and excursion event criteria; and
in response to detecting the triggering event, provide, to a prediction system, an excursion message that comprises (i) a device identifier and (ii) the plurality of sensor-based feature values respectively corresponding to the plurality of excursion feature parameters associated with (a) the entity signature definition and (b) the one or more defined contextual attributes.

13. The system of claim 12, wherein the plurality of radar signals is emitted at a reporting time interval.

14. The system of claim 12, wherein the plurality of movement feature values comprises a first movement subset that corresponds to the entity signature definition and a second movement subset that corresponds to the one or more defined contextual attributes.

15. The system of claim 14, wherein generating the plurality of sensor-based feature values comprises generating a plurality of aggregated feature values that respectively correspond to a first parameter subset of the plurality of excursion feature parameters associated with the entity signature definition by aggregating the first movement subset with a first historical movement subset of the plurality of historical movement feature values.

16. The system of claim 15, wherein generating an aggregated feature value for an excursion feature parameter of the first parameter subset comprises:
identifying a first movement feature value from the first movement subset that corresponds to the excursion feature parameter;
identifying a plurality of second movement feature values from the first historical movement subset that corresponds to the excursion feature parameter; and
generating the aggregated feature value for the excursion feature parameter by aggregating the first movement feature value and the plurality of second movement feature values.

17. The system of claim 15, wherein the excursion event criteria comprise one or more signature-based thresholds that each define a particular threshold range for a particular aggregated feature value of the plurality of aggregated feature values.

18. The system of claim 17, wherein the one or more processors are further configured to:
receive, from the prediction system, one or more tracking target signatures respectively corresponding to the one or more tracking targets; and
modify the one or more signature-based thresholds based on the one or more tracking target signatures.

19. One or more non-transitory computer-readable storage media including instructions that, when executed by one or more processors, cause the one or more processors to:
receive, using a radar sensor, sensor data by emitting a plurality of radar signals within a monitored environment associated with one or more tracking targets;
generate, using the radar sensor, movement data based on the sensor data and that is reflective of a candidate movement for the one or more tracking targets within the monitored environment;
generate a plurality of movement feature values based on the movement data and a plurality of excursion feature parameters associated with (a) an entity signature definition and (b) one or more defined contextual attributes;
generate a plurality of sensor-based feature values for an excursion event based on the plurality of movement feature values and a plurality of historical movement feature values; and
identify a triggering event based on a comparison between the plurality of sensor-based feature values and excursion event criteria; and
in response to detecting the triggering event, provide, to a prediction system, an excursion message that comprises (i) a device identifier and (ii) the plurality of sensor-based feature values respectively corresponding to the plurality of excursion feature parameters associated with (a) the entity signature definition and (b) the one or more defined contextual attributes.

20. The one or more non-transitory computer-readable storage media of claim 19, wherein the radar sensor is configured with an ambient sensing device and the excursion message further comprises a device identifier of the ambient sensing device.
